(19) United States
(12) Patent Application Publication
(10) Pub. No.: US 2026/0032255 A1
(43) Pub. Date: Jan. 29, 2026

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Na ZHANG, Beijing (CN); Kai ZHANG, Los Angeles, CA (US); Li ZHANG, Los Angeles, CA (US)

(21) Appl. No.: 19/344,427

(22) Filed: Sep. 29, 2025

Related U.S. Application Data
(63) Continuation of application No. PCT/CN2024/085080, filed on Mar. 29, 2024.

(30) Foreign Application Priority Data
Mar. 30, 2023 (WO) PCT/CN2023/085199

(51) Int. Cl. H04N 19/137; H04N 19/176

(52) U.S. Cl. CPC H04N 19/137; H04N 19/176

(57) ABSTRACT

Embodiments of the present disclosure provide a solution for video processing. A method for video processing is proposed. In the method, for a conversion between a current video block of a video and a bitstream of the video, a temporal block vector (BV) candidate of the current video block is determined from a temporal position in a collocated picture of the current video block. The conversion is performed based on the temporal BV candidate. At least one of a BV, or a flag of intra block copy with local illumination compensation (IBC-LIC) is inherited from the temporal position.

### CROSS REFERENCE TO RELATED APPLICATIONS

This application is a continuation of International Application No. PCT/CN2024/085080, filed on Mar. 29, 2024, which claims the benefit of International Application No. PCT/CN2023/085199 filed on Mar. 30, 2023. The entire contents of these applications are hereby incorporated by reference in their entireties.

### FIELDS

Embodiments of the present disclosure relate generally to video processing techniques, and more particularly, to temporal block vector (BV) candidate.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a current video block of a video and a bitstream of the video, a temporal block vector (BV) candidate of the current video block from a temporal position in a collocated picture of the current video block; and performing the conversion based on the temporal BV candidate, wherein at least one of a BV, or a flag of intra block copy with local illumination compensation (IBC-LIC) is inherited from the temporal position. In this way, the BV or IBC-LIC flag can be inherited. Thus, the coding effectiveness and coding efficiency can be improved.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining a temporal block vector (BV) candidate of a current video block of the video from a temporal position in a collocated picture of the current video block; and generating the bitstream based on the temporal BV candidate, wherein at least one of a BV, or a flag of intra block copy with local illumination compensation (IBC-LIC) is inherited from the temporal position.

In a fifth aspect, a method for storing a bitstream of a video is proposed. The method comprises: determining a temporal block vector (BV) candidate of a current video block of the video from a temporal position in a collocated picture of the current video block; generating the bitstream based on the temporal BV candidate; and storing the bitstream in a non-transitory computer-readable recording medium, wherein at least one of a BV, or a flag of intra block copy with local illumination compensation (IBC-LIC) is inherited from the temporal position.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates spatial neighboring positions used in IBC vector prediction;

FIG. 5 illustrates current CTU processing order and its available reference samples in current and left CTU;

FIG. 6 illustrates spatial neighboring positions used in IBC merge/AMVP list construction;

FIG. 7 illustrates padding candidates for the replacement of the zero-vector in the IBC list;

FIG. 8 illustrates IBC reference region depending on current CU position;

FIG. 9 illustrates a reference area for IBC when CTU (m,n) is coded. The blue block denotes the current CTU; green blocks denote the reference area; and the white blocks denote invalid reference area;

FIG. 10A illustrates an illustration of BV adjustment for horizontal flip;

FIG. 10B illustrates an illustration of BV adjustment for vertical flip;

FIG. 11 illustrates an intra template matching search area used;

FIG. 12 illustrates use of IntraTMP block vector for IBC block;

FIG. 13A illustrates an example of IBC block vector candidate list existing only IBC block vectors;

FIG. 13B illustrates an example of IBC block vector candidate list existing both IBC and IntraTMP block vectors;

FIG. 14 illustrates template and reference samples of the template in reference pictures;

FIG. 15 illustrates template and reference samples of the template for block with sub-block motion using the motion information of the subblocks of the current block;

FIG. 16 illustrates positions of spatial merge candidate;

FIG. 17 illustrates candidate pairs considered for redundancy check of spatial merge candidates;

FIG. 18 illustrates an illustration of motion vector scaling for temporal merge candidate;

FIG. 19 illustrates candidate positions for temporal merge candidate, C0 and C1;

FIG. 20 illustrates spatial neighboring blocks used to derive the spatial merge candidates;

FIG. 21A illustrates spatial neighboring blocks used by ATVMP;

FIG. 21B illustrates deriving sub-CU motion field by applying a motion shift from spatial neighbor and scaling the motion information from the corresponding collocated sub-CUS;

FIG. 22A illustrates candidate positions for spatial candidate;

FIG. 22B illustrates candidate positions for temporal candidate;

FIG. 23 illustrates candidate positions for the temporal BV candidates, spatial can be Left, Above, Above-right, Bottom-left, or Above-left;

FIG. 24 illustrates candidate positions for the temporal BV candidates;

FIG. 25 illustrates a first pattern of candidate positions for the temporal BV candidates;

FIG. 26 illustrates a second pattern of candidate positions for the temporal BV candidates;

FIG. 27 illustrates a flowchart of a method for video processing in accordance with embodiments of the present disclosure; and

FIG. 28 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

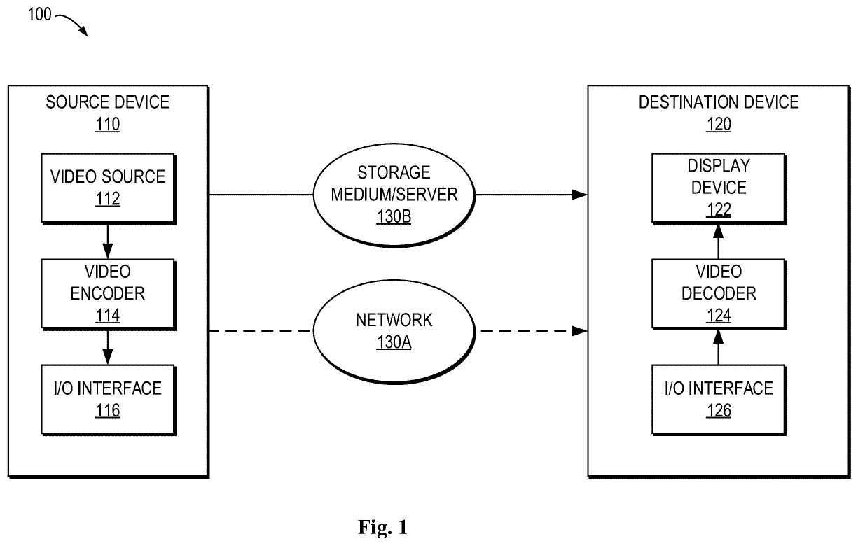

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

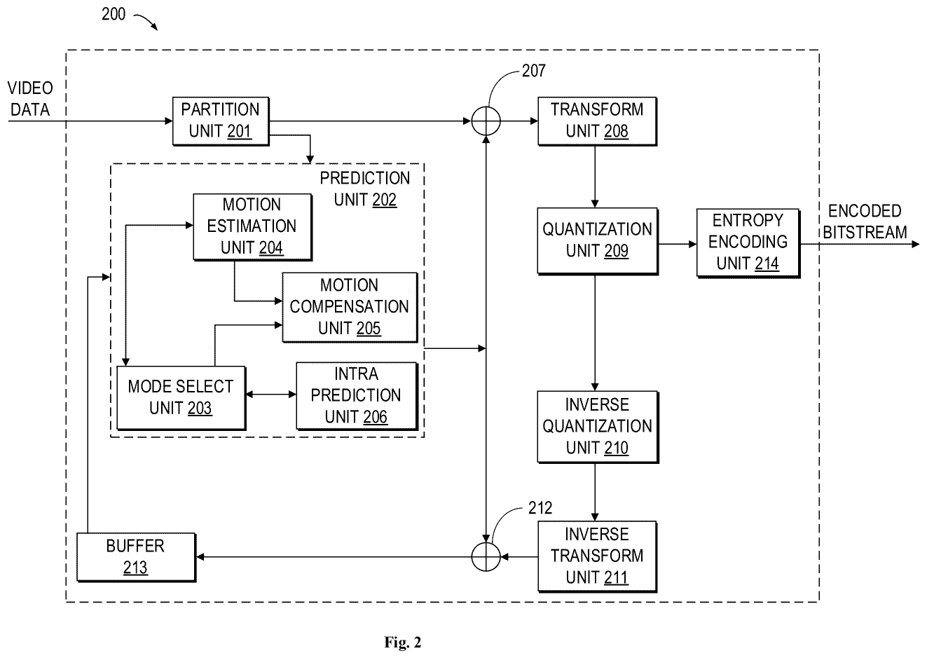

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

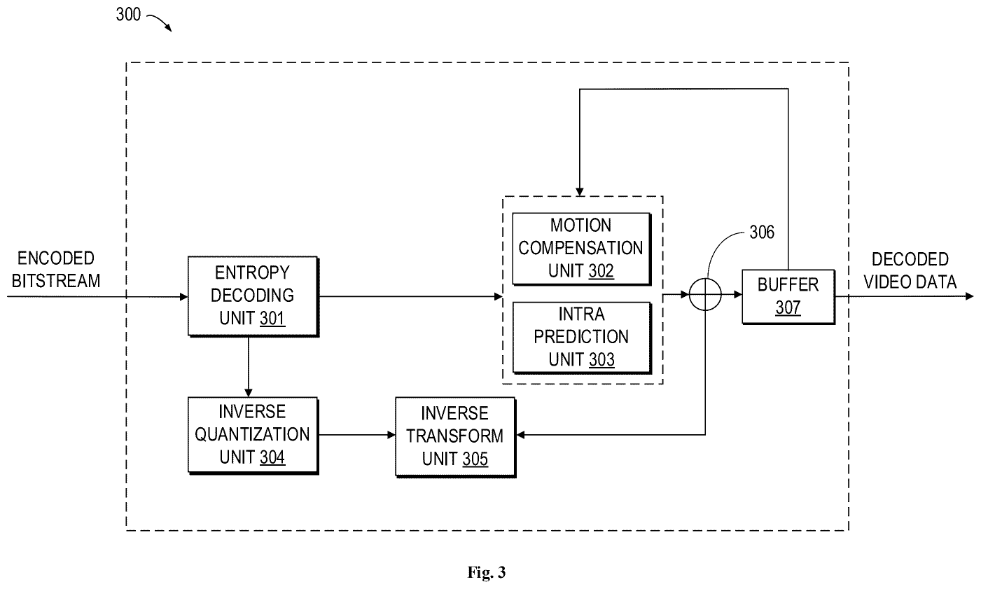

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. BRIEF SUMMARY

This disclosure is related to image/video coding, especially on temporal block vector prediction. It may be applied to the existing video coding standard like HEVC, or the standard VVC (Versatile Video Coding). It may be also applicable to future video coding standards or video codec.

### 2. INTRODUCTION

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized.

To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.

In January 2021, JVET established an Exploration Experiment (EE), targeting at enhanced compression efficiency beyond VVC capability with novel traditional algorithms. Soon later, ECM was built as the common software base for longer-term exploration work towards the next generation video coding standard.

### 2.1. Intra Block Copy (IBC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 subblocks. For the current block of a larger size, a hash key is determined to match that of the reference block when all the hash keys of all 4×4 subblocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signaled as IBC AMVP mode or IBC skip/merge mode as follows:
IBC skip/merge mode: a merge candidate index is used to indicate which of the block vectors in the list from neighboring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbor and one from above neighbor (if IBC coded). When either neighbor is not available, a default block vector will be used as a predictor. A flag is signaled to indicate the block vector predictor index.

### 2.1.1. Simplification of IBC Vector Prediction

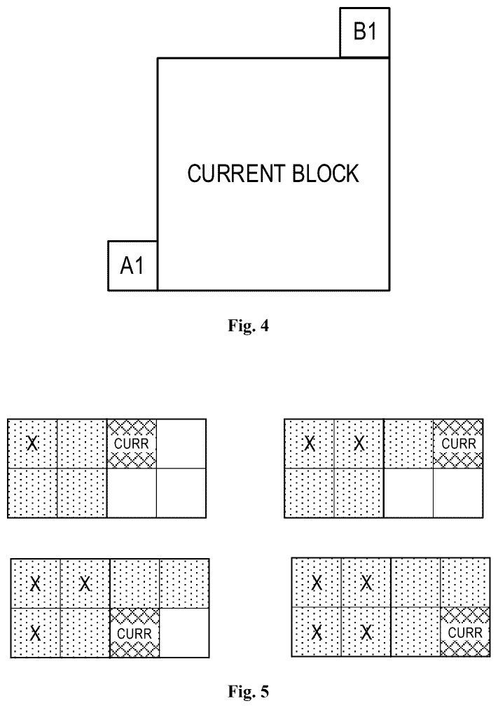

The BV predictors for merge mode and AMVP mode in IBC will share a common predictor list, which consist of the following elements:
2 spatial neighboring positions (A1, B1 as in FIG. 4, which illustrates the spatial neighboring positions used in IBC vector prediction),
5 HMVP entries,
Zero vectors by default.

For merge mode, up to first 6 entries of this list will be used; for AMVP mode, the first 2 entries of this list will be used. And the list conforms with the shared merge list region requirement (shared the same list within the SMR).

### 2.1.2. IBC Reference Region

To reduce memory consumption and decoder complexity, the IBC in VVC allows only the reconstructed portion of the predefined area including the region of current CTU and some region of the left CTU. FIG. 5 illustrates the reference region of IBC Mode, where each block represents 64×64 luma sample unit. FIG. 5 illustrates current CTU processing order and its available reference samples in current and left CTU.

Depending on the location of the current coding CU location within the current CTU, the following applies:
If current block falls into the top-left 64×64 block of the current CTU, then in addition to the already reconstructed samples in the current CTU, it can also refer to the reference samples in the bottom-right 64×64 blocks of the left CTU, using CPR mode. The current block can also refer to the reference samples in the bottom-left 64×64 block of the left CTU and the reference samples in the top-right 64×64 block of the left CTU, using CPR mode.
If current block falls into the top-right 64×64 block of the current CTU, then in addition to the already reconstructed samples in the current CTU, if luma location (0, 64) relative to the current CTU has not yet been reconstructed, the current block can also refer to the reference samples in the bottom-left 64×64 block and bottom-right 64×64 block of the left CTU, using CPR mode; otherwise, the current block can also refer to reference samples in bottom-right 64×64 block of the left CTU.
If current block falls into the bottom-left 64×64 block of the current CTU, then in addition to the already reconstructed samples in the current CTU, if luma location (64, 0) relative to the current CTU has not yet been reconstructed, the current block can also refer to the reference samples in the top-right 64×64 block and bottom-right 64×64 block of the left CTU, using CPR mode. Otherwise, the current block can also refer to the reference samples in the bottom-right 64×64 block of the left CTU, using CPR mode.
If current block falls into the bottom-right 64×64 block of the current CTU, it can only refer to the already reconstructed samples in the current CTU, using CPR mode.

This restriction allows the IBC mode to be implemented using local on-chip memory for hardware implementations.

2.1.3. IBC Interaction with Other Coding Tools

The interaction between IBC mode and other inter coding tools in VVC, such as pairwise merge candidate, history-based motion vector predictor (HMVP), combined intra/inter prediction mode (CIIP), merge mode with motion vector difference (MMVD), and geometric partitioning mode (GPM) are as follows:
IBC can be used with pairwise merge candidate and HMVP. A new pairwise IBC merge candidate can be generated by averaging two IBC merge candidates. For HMVP, IBC motion is inserted into history buffer for future referencing.
IBC cannot be used in combination with the following inter tools: affine motion, CIIP, MMVD, and GPM.
IBC is not allowed for the chroma coding blocks when DUAL_TREE partition is used.

Unlike in the HEVC screen content coding extension, the current picture is no longer included as one of the reference pictures in the reference picture list 0 for IBC prediction. The derivation process of motion vectors for IBC mode excludes all neighboring blocks in inter mode and vice versa. The following IBC design aspects are applied:
IBC shares the same process as in regular MV merge including with pairwise merge candidate and history-based motion predictor, but disallows TMVP and zero vector because they are invalid for IBC mode.
Separate HMVP buffer (5 candidates each) is used for conventional MV and IBC.
Block vector constraints are implemented in the form of bitstream conformance constraint, the encoder needs to ensure that no invalid vectors are present in the bitstream, and merge shall not be used if the merge candidate is invalid (out of range or 0). Such bitstream conformance constraint is expressed in terms of a virtual buffer as described below.
For deblocking, IBC is handled as inter mode.
If the current block is coded using IBC prediction mode, AMVR does not use quarter-pel; instead, AMVR is signaled to only indicate whether MV is inter-pel or 4 integer-pel.
The number of IBC merge candidates can be signalled in the slice header separately from the numbers of regular, subblock, and geometric merge candidates.

A virtual buffer concept is used to describe the allowable reference region for IBC prediction mode and valid block vectors. Denote CTU size as ctbSize, the virtual buffer, ibcBuf, has width being wIbcBuf=128×128/ctbSize and height hIbcBuf=ctbSize. For example, for a CTU size of 128×128, the size of ibcBuf is also 128×128; for a CTU size of 64×64, the size of ibcBuf is 256×64; and a CTU size of 32×32, the size of ibcBuf is 512×32.

The size of a VPDU is min (ctbSize, 64) in each dimension, Wᵥ=min (ctbSize, 64).

The virtual IBC buffer, ibcBuf is maintained as follows.
At the beginning of decoding each CTU row, refresh the whole ibcBuf with an invalid value −1.
At the beginning of decoding a VPDU (xVPDU, yVPDU) relative to the top-left corner of the picture, set the ibcBuf [x][y]=−1, with x=xVPDU%wIbcBuf, . . . , xVPDU%wIbcBuf+Wᵥ−1; y=yVPDU%ctbSize, . . . , yVPDU%ctbSize+Wᵥ−1.
After decoding a CU contains (x, y) relative to the top-left corner of the picture, set

$$ibcBuf [ x \% wIbcBuf ] [ y \% ctbSize ] = recSample [ x ] [ y ]$$

For a block covering the coordinates (x, y), if the following is true for a block vector bv=(bv[0], bv[1]), then it is valid; otherwise, it is not valid:

$$ibcBuf [ ( x + bv [ 0 ] ) \% wIbcBuf ] [ ( y + bv [ 1 ] ) \% ctbSize ] \text{} shall not be equal to - \text{} 1.$$

### 2.1.4. IBC Virtual Buffer Test

A luma block vector bvL (the luma block vector in 1/16 fractional-sample accuracy) shall obey the following constraints:
CtbSizeY is greater than or equal to ((yCb+(bvL [1]>>4)) & (CtbSizeY−1))+cbHeight.

$$IbcVirBuf [ \text{} 0 ] [ \text{} ( x + ( bvL [ 0 ] ≫ 4 ) ) \& \text{} ( IbcBufWidthY - 1 ) ] [ \text{} ( y + ( bvL [ 1 ] ≫ 4 ) ) \& ( CtbSizeY - 1 ) ] shall not be equal to - 1 for x = xCb … xCb + cbWidth - 1 and y = yCb … yCb + cbHeight - 1.$$

Otherwise, bvL is considered as an invalid bv.

The samples are processed in units of CTBs. The array size for each luma CTB in both width and height is CtbSizeY in units of samples.
(xCb, yCb) is a luma location of the top-left sample of the current luma coding block relative to the top-left luma sample of the current picture,
cbWidth specifies the width of the current coding block in luma samples,
cbHeight specifies the height of the current coding block in luma samples.

### 2.2. IBC Merge/AMVP List Construction

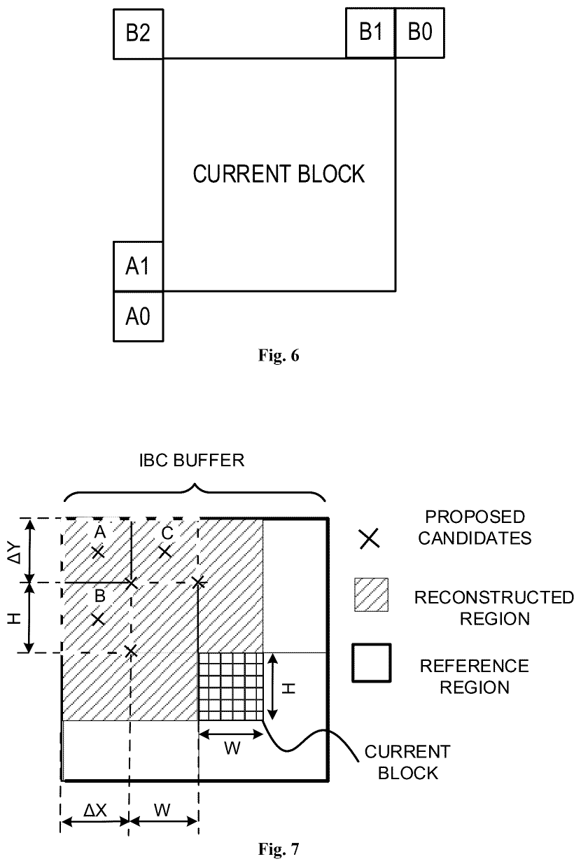

The IBC merge/AMVP list construction is modified as follows:
Only if an IBC merge/AMVP candidate is valid, it can be inserted into the IBC merge/AMVP candidate list.
Above-right, bottom-left, and above-left spatial candidates (B0, A0, and B2 as shown in FIG. 6, which illustrates spatial neighboring positions used in IBC merge/AMVP list construction), and one pairwise average candidate can be added into the IBC merge/AMVP candidate list.
Template based adaptive reordering (ARMC-TM) is applied to IBC merge list.

The HMVP table size for IBC is increased to 25. After up to 20 IBC merge candidates are derived with full pruning, they are reordered together. After reordering, the first 6 candidates with the lowest template matching costs are selected as the final candidates in the IBC merge list.

The zero vectors' candidates to pad the IBC Merge/AMVP list are replaced with a set of BVP candidates located in the IBC reference region. A zero vector is invalid as a block vector in IBC merge mode, and consequently, it is discarded as BVP in the IBC candidate list.

Three candidates are located on the nearest corners of the reference region, and three additional candidates are determined in the middle of the three sub-regions (A, B, and C), whose coordinates are determined by the width, and height of the current block and the ΔX and ΔY parameters, as is depicted in FIG. 7, which illustrates padding candidates for the replacement of the zero-vector in the IBC list.

2.3. IBC with Template Matching

Template Matching is used in IBC for both IBC merge mode and IBC AMVP mode.

The IBC-TM merge list is modified compared to the one used by regular IBC merge mode such that the candidates are selected according to a pruning method with a motion distance between the candidates as in the regular TM merge mode. The ending zero motion fulfillment is replaced by motion vectors to the left (−W, 0), top (0, −H) and top-left (−W, −H), where W is the width and H the height of the current CU.

In the IBC-TM merge mode, the selected candidates are refined with the Template Matching method prior to the RDO or decoding process. The IBC-TM merge mode has been put in competition with the regular IBC merge mode and a TM-merge flag is signaled.

In the IBC-TM AMVP mode, up to 3 candidates are selected from the IBC-TM merge list. Each of those 3 selected candidates are refined using the Template Matching method and sorted according to their resulting Template Matching cost. Only the 2 first ones are then considered in the motion estimation process as usual.

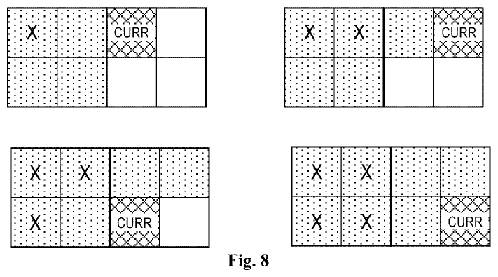

The Template Matching refinement for both IBC-TM merge and AMVP modes is quite simple since IBC motion vectors are constrained (i) to be integer and (ii) within a reference region as shown in FIG. 8, which illustrates IBC reference region depending on current CU position. So, in IBC-TM merge mode, all refinements are performed at integer precision, and in IBC-TM AMVP mode, they are performed either at integer or 4-pel precision depending on the AMVR value. Such a refinement accesses only to samples without interpolation. In both cases, the refined motion vectors and the used template in each refinement step must respect the constraint of the reference region.

### 2.4. IBC Reference Area

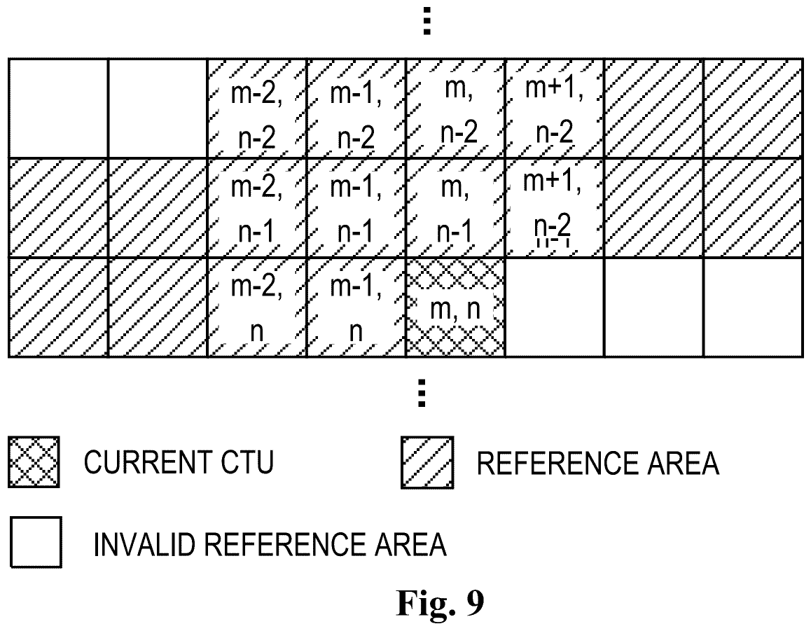

The reference area for IBC is extended to two CTU rows above. FIG. 9 illustrates the reference area for coding CTU (m,n). Specifically, for CTU (m,n) to be coded, the reference area includes CTUs with index (m−2,n−2) . . . (W,n−2), (0,n−1) . . . (W,n−1), (0,n) . . . (m,n), where W denotes the maximum horizontal index within the current tile, slice or picture. When CTU size is 256, the reference area is limited to one CTU row above. This setting ensure that for CTU size being 128 or 256, IBC does not require extra memory in the current ETM platform. The per-sample block vector search (or called local search) range is limited to [−(C<<1), C>>2] horizontally and [−C, C>>2] vertically to adapt to the reference area extension, where C denotes the CTU size.

### 2.5. Reconstruction-Reordered IBC (RR-IBC)

A Reconstruction-Reordered IBC (RR-IBC) mode is allowed for IBC coded blocks. When RR-IBC is applied, the samples in a reconstruction block are flipped according to a flip type of the current block. At the encoder side, the original block is flipped before motion search and residual calculation, while the prediction block is derived without flipping. At the decoder side, the reconstruction block is flipped back to restore the original block.

Two flip methods, horizontal flip and vertical flip, are supported for RR-IBC coded blocks. A syntax flag is firstly signalled for an IBC AMVP coded block, indicating whether the reconstruction is flipped, and if it is flipped, another flag is further signaled specifying the flip type. For IBC merge, the flip type is inherited from neighbouring blocks, without syntax signalling. Considering the horizontal or vertical symmetry, the current block and the reference block are normally aligned horizontally or vertically. Therefore, when a horizontal flip is applied, the vertical component of the BV is not signaled and inferred to be equal to 0. Similarly, the horizontal component of the BV is not signaled and inferred to be equal to 0 when a vertical flip is applied.

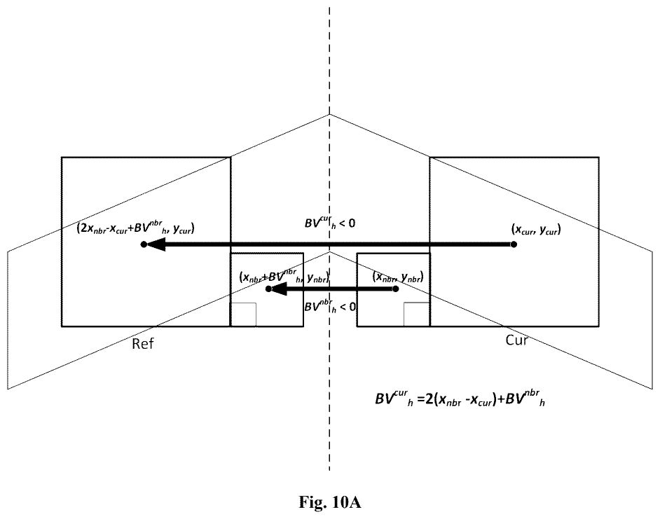

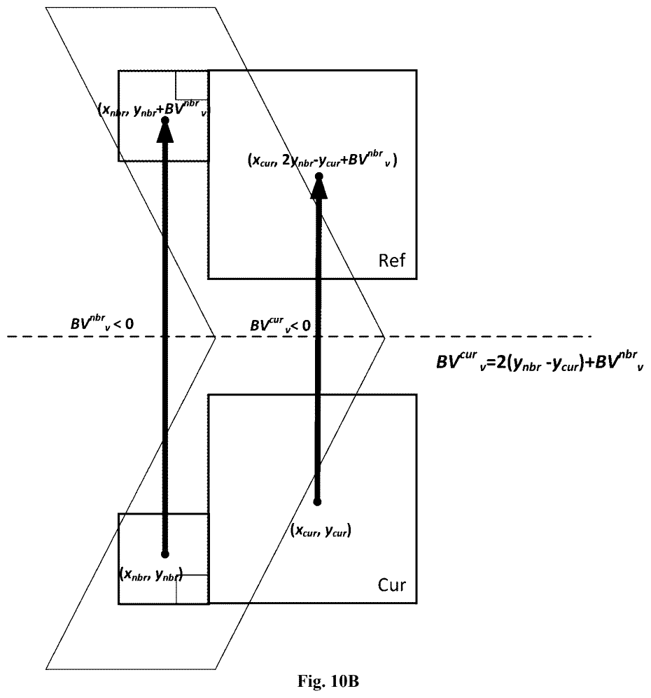

FIG. 10A illustrates an illustration of BV adjustment for horizontal flip. FIG. 10B illustrates an illustration of BV adjustment for vertical flip.

To better utilize the symmetry property, a flip-aware BV adjustment approach is applied to refine the block vector candidate. For example, as shown in FIG. 10A and FIG. 10B, (x_{nbr}, y_{nbr}) and (x_{cur}, y_{cur}) represent the coordinates of the center sample of the neighbouring block and the current block, respectively, BV^{nbr} and BV^{cur} denotes the BV of the neighbouring block and the current block, respectively. Instead of directly inheriting the BV from a neighbouring block, the horizontal component of BV^{cur} is calculated by adding a motion shift to the horizontal component of BV^{nbr} (denoted as BV^{nbr}ₕ) in case that the neighbouring block is coded with a horizontal flip, i.e., BV^{cur}ₕ=2(x_{nbr}−x_{cur})+BV^{nbr}ᵥ. Similarly, the vertical component of BV^{cur} is calculated by adding a motion shift to the vertical component of BV^{nbr} (denoted as BV^{nbr}ᵥ) in case that the neighbouring block is coded with a vertical flip, i.e., BV^{cur}ᵥ=2 (y_{nbr}−y_{cur})+BV^{nbr}ᵥ.

2.6. IBC Merge Mode with Block Vector Differences (IBC-MBVD)

Affine-MMVD and GPM-MMVD have been adopted to ECM as an extension of regular MMVD mode. It is natural to extend the MMVD mode to the IBC merge mode.

In IBC-MBVD, the distance set is {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the BVD directions are two horizontal and two vertical directions.

The base candidates are selected from the first five candidates in the reordered IBC merge list. And based on the SAD cost between the template (one row above and one column left to the current block) and its reference for each refinement position, all the possible MBVD refinement positions (20×4) for each base candidate are reordered. Finally, the top 8 refinement positions with the lowest template SAD costs are kept as available positions, consequently for MBVD index coding. The MBVD index is binarized by the rice code with the parameter equal to 1.

An IBC-MBVD coded block does not inherit flip type from a RR-IBC coded neighbor block.

### 2.7. Intra Template Matching

Intra template matching prediction (Intra TMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

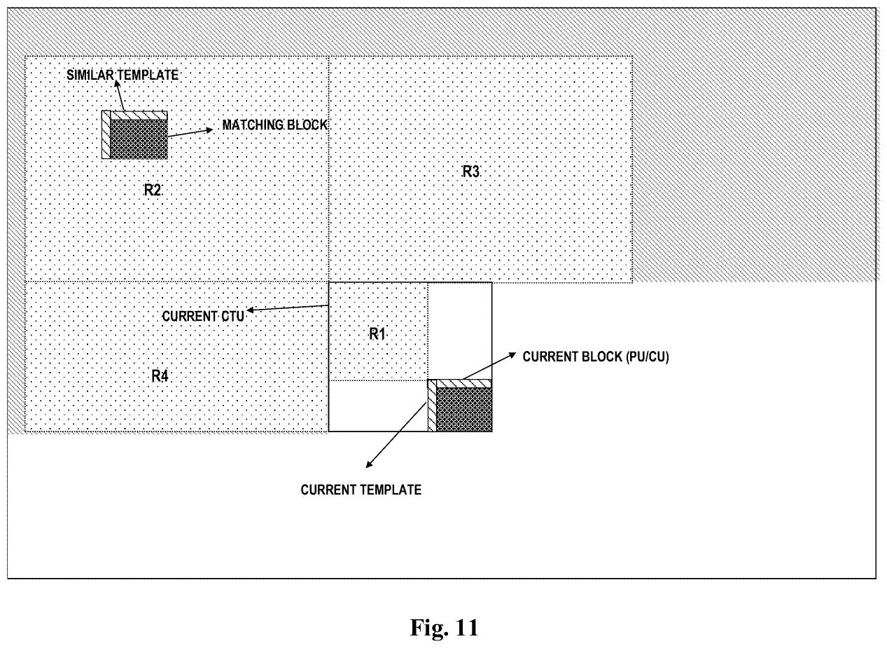

FIG. 11 illustrates an intra template matching search area used. The prediction signal is generated by matching the L-shaped causal neighbor of the current block with another block in a predefined search area in FIG. 11 consisting of:

R1: current CTU,

R2: top-left CTU,

R3: above CTU,

R4: left CTU.

Sum of absolute differences (SAD) is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

$$\begin{matrix}SearchRange\_w = a * BlkW , \\ SearchRange\_h = a * BlkH .\end{matrix}$$

Where ‘a’ is a constant that controls the gain/complexity trade-off. In practice, ‘a’ is equal to 5.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

2.8. Using Block Vector Derived from IntraTMP for IBC

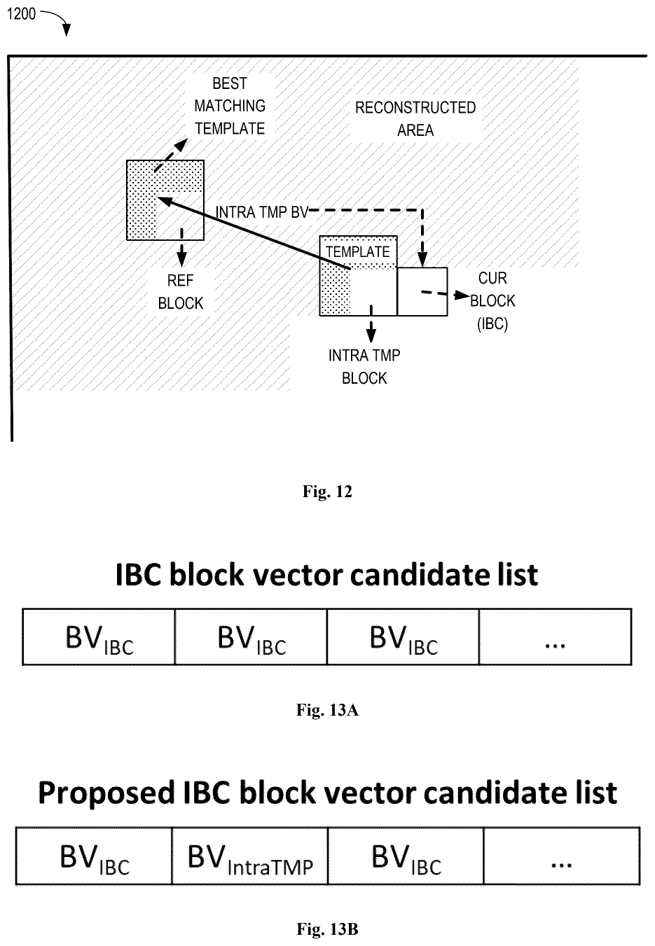

Using block vector derived from IntraTMP for IBC was proposed. The proposed method is to store IntraTMP block vector in the IBC block vector buffer and, the current IBC block can use both IBC BV and IntraTMP BV of neighbouring blocks as BV candidate for IBC BV candidate list as shown in FIG. 12, which illustrates use of IntraTMP block vector for IBC block.

FIG. 13A and FIG. 13B show examples of comparing the block vector candidates which are from only IBC coded neighbouring blocks in the IBC block vector candidate list and the block vector candidates which are from both IBC and IntraTMP coded neighbouring blocks in the proposed IBC block vector candidate list. The IntraTMP block vectors are added to IBC block vector candidate list as spatial candidates.

FIG. 13A illustrates an example of IBC block vector candidate list existing only IBC block vectors. FIG. 13B illustrates an example of IBC block vector candidate list existing both IBC and IntraTMP block vectors. It is noted that the proposed method makes IBC block vector prediction more efficient by using diverse block vectors without additional memory for storing block vectors.

2.9. Adaptive Reordering of Merge Candidates with Template Matching (ARMC-TM)

The merge candidates are adaptively reordered with template matching (TM). The reordering method is applied to regular merge mode, TM merge mode, and affine merge mode (excluding the SbTMVP candidate). For the TM merge mode, merge candidates are reordered before the refinement process.

An initial merge candidate list is firstly constructed according to given checking order, such as spatial, TMVPs, non-adjacent, HMVPs, pairwise, virtual merge candidates. Then the candidates in the initial list are divided into several subgroups. For the template matching (TM) merge mode, adaptive DMVR mode, each merge candidate in the initial list is firstly refined by using TM/multi-pass DMVR. Merge candidates in each subgroup are reordered to generate a reordered merge candidate list and the reordering is according to cost values based on template matching. The index of selected merge candidate in the reordered merge candidate list is signalled to the decoder. For simplification, merge candidates in the last but not the first subgroup are not reordered. All the zero candidates from the ARMC reordering process are excluded during the construction of Merge motion vector candidates list. The subgroup size is set to 5 for regular merge mode and TM merge mode. The subgroup size is set to 3 for affine merge mode.

### Cost Calculation

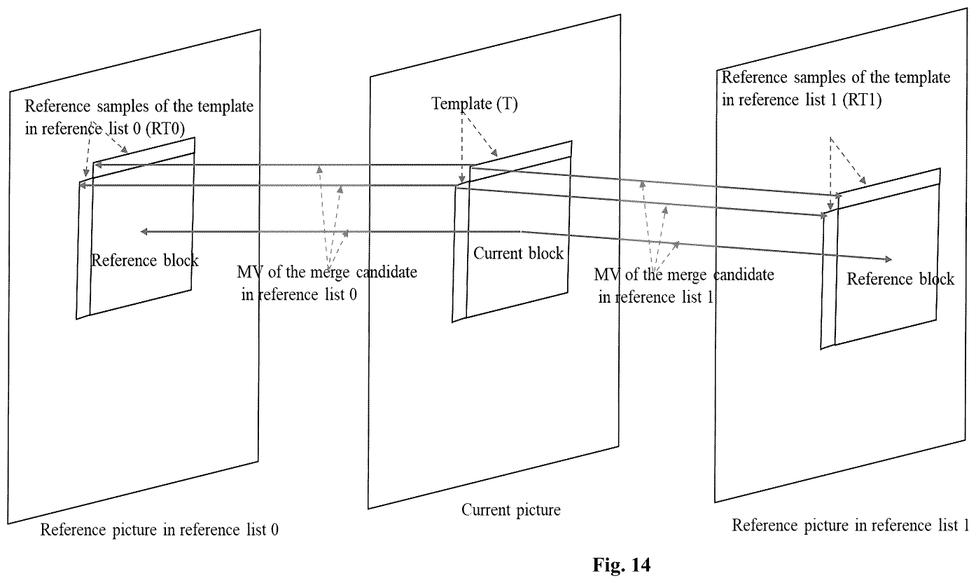

The template matching cost of a merge candidate during the reordering process is measured by the SAD between samples of a template of the current block and their corresponding reference samples. The template comprises a set of reconstructed samples neighboring to the current block. Reference samples of the template are located by the motion information of the merge candidate. When a merge candidate utilizes bi-directional prediction, the reference samples of the template of the merge candidate are also generated by bi-prediction as shown in FIG. 14, which illustrates template and reference samples of the template in reference pictures.

### Refinement of the Initial Merge Candidate List

When multi-pass DMVR is used to derive the refined motion to the initial merge candidate list only the first pass (i.e., PU level) of multi-pass DMVR is applied in reordering. When template matching is used to derive the refined motion, the template size is set equal to 1. Only the above or left template is used during the motion refinement of TM when the block is flat with block width greater than 2 times of height or narrow with height greater than 2 times of width. TM is extended to perform 1/16-pel MVD precision. The first four merge candidates are reordered with the refined motion in TM merge mode.

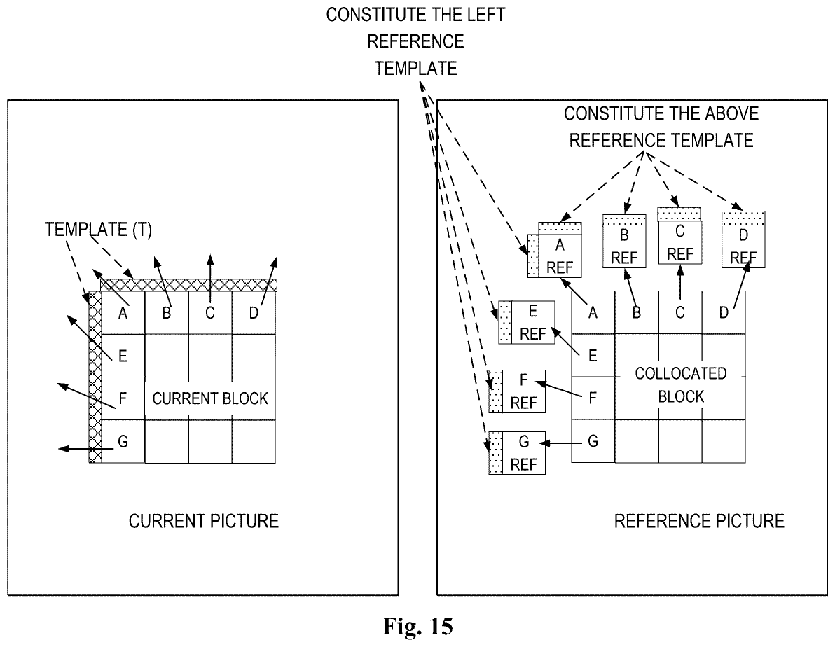

For subblock-based merge candidates with subblock size equal to Wsub×Hsub, the above template comprises several sub-templates with the size of Wsub×1, and the left template comprises several sub-templates with the size of 1×Hsub. As shown in FIG. 15, which illustrates template and reference samples of the template for block with sub-block motion using the motion information of the subblocks of the current block, the motion information of the subblocks in the first row and the first column of current block is used to derive the reference samples of each sub-template.

### Reordering Criterial

In the reordering process, a candidate is considered as redundant if the cost difference between a candidate and its predecessor is inferior to a lambda value e.g. |D1−D2|<λ, where D1 and D2 are the costs obtained during the first ARMC ordering and λ is the Lagrangian parameter used in the RD criterion at encoder side.

The proposed algorithm is defined as the following:
Determine the minimum cost difference between a candidate and its predecessor among all candidates in the list.
   If the minimum cost difference is superior or equal to 2, the list is considered diverse enough and the reordering stops.
   If this minimum cost difference is inferior to λ, the candidate is considered as redundant and it is moved at a further position in the list. This further position is the first position where the candidate is diverse enough compared to its predecessor.
The algorithm stops after a finite number of iterations (if the minimum cost difference is not inferior to λ).

This algorithm is applied to the Regular, TM, BM and Affine merge modes. A similar algorithm is applied to the Merge MMVD and sign MVD prediction methods which also use ARMC for the reordering.

The value of λ is set equal to the λ of the rate distortion criterion used to select the best merge candidate at the encoder side for low delay configuration and to the value λ corresponding to a another QP for Random Access configuration. A set of λ values corresponding to each signaled QP offset is provided in the SPS or in the Slice Header for the QP offsets which are not present in the SPS.

### Extension to AMVP Modes

The ARMC design is also applicable to the AMVP mode wherein the AMVP candidates are reordered according to the TM cost. For the template matching for advanced motion vector prediction (TM-AMVP) mode, an initial AMVP candidate list is constructed, followed by a refinement from TM to construct a refined AMVP candidate list. In addition, an MVP candidate with a TM cost larger than a threshold, which is equal to five times of the cost of the first MVP candidate, is skipped.

Note, when wrap around motion compensation is enabled, the MV candidate shall be clipped with wrap around offset taken into consideration.

### 2.10. Extended Merge Prediction

In VVC, the merge candidate list is constructed by including the following five types of candidates in order:
1) Spatial MVP from spatial neighbour CUS,
2) Temporal MVP from collocated CUs,
3) History-based MVP from an FIFO table,
4) Pairwise average MVP,
5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merging candidate lists for all CUs within a certain size of area.

### 2.10.1. Spatial Candidates Derivation

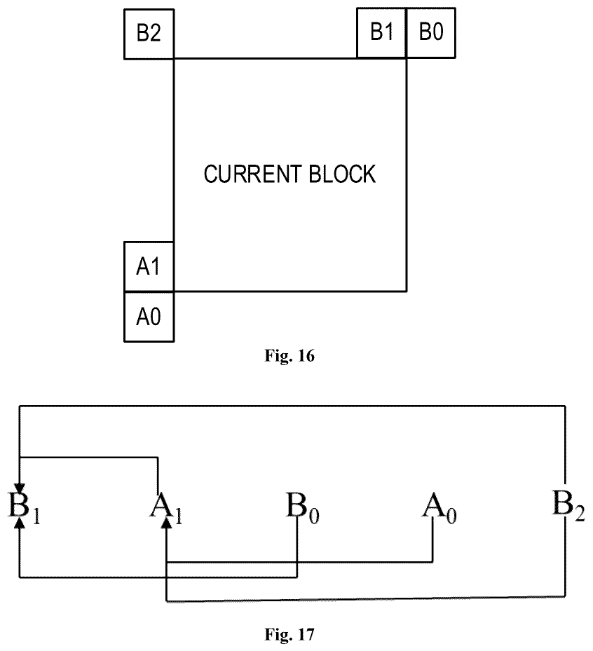

The derivation of spatial merge candidates in VVC is same to that in HEVC except the positions of first two merge candidates are swapped. A maximum of four merge candidates are selected among candidates located in the positions depicted in FIG. 16, which illustrates positions of spatial merge candidate. The order of derivation is B₁, A₁, B₀, A₀ and B₂. Position B₂ is considered only when one or more than one CUs of position B₀, A₀, B₁, A₁ are not available (e.g. because it belongs to another slice or tile) or is intra coded. After candidate at position B₁ is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. FIG. 17 illustrates candidate pairs considered for redundancy check of spatial merge candidates. Instead only the pairs linked with an arrow in FIG. 17 are considered and a candidate is only added to the list if the corresponding candidate used for redundancy check has not the same motion information.

### 2.10.2. Temporal Candidates Derivation

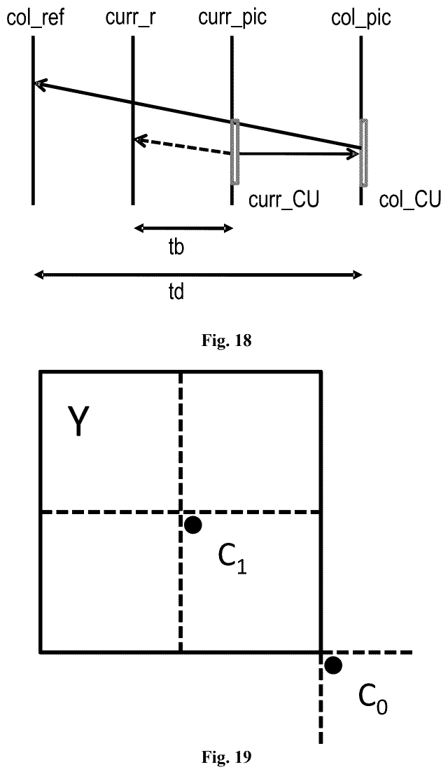

In this step, only one candidate is added to the list. Particularly, in the derivation of this temporal merge candidate, a scaled motion vector is derived based on co-located CU belonging to the collocated reference picture. The reference picture list and the reference index to be used for derivation of the co-located CU is explicitly signalled in the slice header. The scaled motion vector for temporal merge candidate is obtained as illustrated by the dotted line in FIG. 18, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

The position for the temporal candidate is selected between candidates C₀ and C₁, as depicted in FIG. 19. If CU at position C₀ is not available, is intra coded, or is outside of the current row of CTUs, position C₁ is used. Otherwise, position C₀ is used in the derivation of the temporal merge candidate.

### 2.10.3. History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 5 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward, and the identical HMVP is inserted to the last entry of the table.

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications are introduced:
1. The last two entries in the table are redundancy checked to A₁ and B₁ spatial candidates, respectively.
2. Once the total number of available merge candidates reaches the maximally allowed merge candidates minus 1, the merge candidate list construction process from HMVP is terminated.

### 2.10.4. Pair-Wise Average Merge Candidate Derivation

Pairwise average candidates are generated by averaging predefined pairs of candidates in the existing merge candidate list, using the first two merge candidates. The first merge candidate is defined as p0Cand and the second merge candidate can be defined as p1Cand, respectively. The averaged motion vectors are calculated according to the availability of the motion vector of p0Cand and p1Cand separately for each reference list. If both motion vectors are available in one list, these two motion vectors are averaged even when they point to different reference pictures, and its reference picture is set to the one of p0Cand; if only one motion vector is available, use the one directly; if no motion vector is available, keep this list invalid. Also, if the half-pel interpolation filter indices of p0Cand and p1Cand are different, it is set to 0.

When the merge list is not full after pair-wise average merge candidates are added, the zero MVPs are inserted in the end until the maximum merge candidate number is encountered.

### 2.10.5. Merge Estimation Region

Merge estimation region (MER) allows independent derivation of merge candidate list for the CUs in the same merge estimation region (MER). A candidate block that is within the same MER to the current CU is not included for the generation of the merge candidate list of the current CU. In addition, the updating process for the history-based motion vector predictor candidate list is updated only if (xCb+cbWidth)>>Log 2ParMrgLevel is greater than xCb>>Log 2ParMrgLevel and (yCb+cbHeight)>>Log 2ParMrgLevel is great than (yCb>>Log 2ParMrgLevel) and where (xCb, yCb) is the top-left luma sample position of the current CU in the picture and (cbWidth, cbHeight) is the CU size. The MER size is selected at encoder side and signalled as log 2_parallel_merge_level_minus2 in the sequence parameter set.

### 2.10.6. Non-Adjacent Spatial Candidate

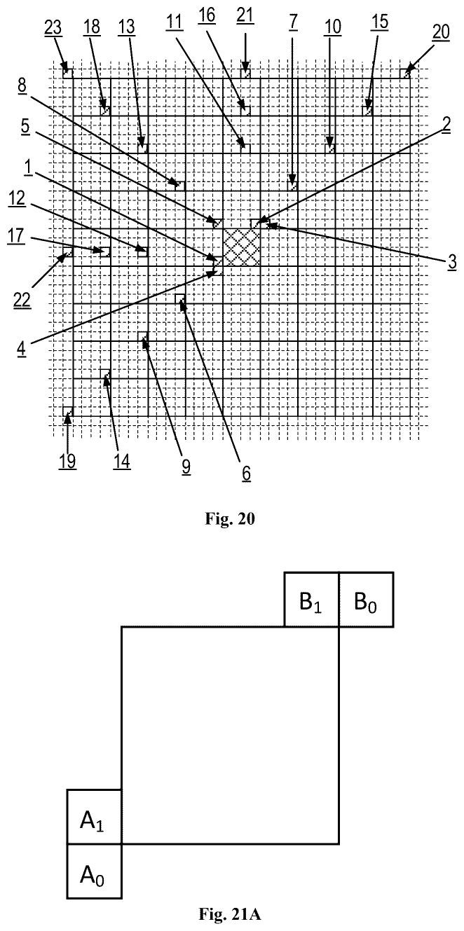

In ECM, the non-adjacent spatial merge candidates as in JVET-L0399 are inserted after the TMVP in the regular merge candidate list. The pattern of spatial merge candidates is shown in FIG. 20, which illustrates spatial neighboring blocks used to derive the spatial merge candidates. The distances between non-adjacent spatial candidates and current coding block are based on the width and height of current coding block. The line buffer restriction is not applied.

### 2.10.7. MV Candidate Type Based ARMC

Merge candidates of one single candidate type, e.g., TMVP or non-adjacent MVP (NA-MVP), are reordered based on the ARMC TM cost values. The reordered candidates are then added into the merge candidate list. The TMVP candidate type adds more TMVP candidates with more temporal positions and different inter prediction directions to perform the reordering and the selection. Moreover, NA-MVP candidate type is further extended with more spatially non-adjacent positions. The target reference picture of the TMVP candidate can be selected from any one of reference picture in the list according to scaling factor. The selected reference picture is the one whose scaling factor is the closest to 1.

### 2.11. Subblock-Based Temporal Motion Vector Prediction (SbTMVP)

VVC supports the subblock-based temporal motion vector prediction (SbTMVP) method. Similar to the temporal motion vector prediction (TMVP) in HEVC, SbTMVP uses the motion field in the collocated picture to improve motion vector prediction and merge mode for CUs in the current picture. The same collocated picture used by TMVP is used for SbTVMP. SbTMVP differs from TMVP in the following two main aspects:
TMVP predicts motion at CU level but SbTMVP predicts motion at sub-CU level;
Whereas TMVP fetches the temporal motion vectors from the collocated block in the collocated picture (the collocated block is the bottom-right or center block relative to the current CU), SbTMVP applies a motion shift before fetching the temporal motion information from the collocated picture, where the motion shift is obtained from the motion vector from one of the spatial neighboring blocks of the current CU.

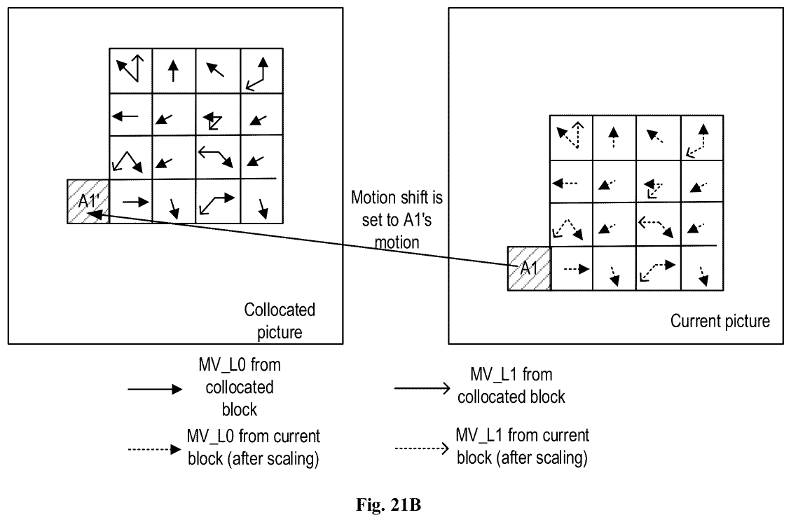

The SbTVMP process is illustrated in FIG. 21A and FIG. 21B. FIG. 21A illustrates spatial neighboring blocks used by ATVMP. FIG. 21B illustrates deriving sub-CU motion field by applying a motion shift from spatial neighbor and scaling the motion information from the corresponding collocated sub-CUs. SbTMVP predicts the motion vectors of the sub-CUs within the current CU in two steps. In the first step, the spatial neighbor A1 in FIG. 21A is examined. If A1 has a motion vector that uses the collocated picture as its reference picture, this motion vector is selected to be the motion shift to be applied. If no such motion is identified, then the motion shift is set to (0, 0).

In the second step, the motion shift identified in Step 1 is applied (i.e. added to the current block's coordinates) to obtain sub-CU level motion information (motion vectors and reference indices) from the collocated picture as shown in FIG. 21B. The example in FIG. 21B assumes the motion shift is set to block A1's motion. Then, for each sub-CU, the motion information of its corresponding block (the smallest motion grid that covers the center sample) in the collocated picture is used to derive the motion information for the sub-CU. After the motion information of the collocated sub-CU is identified, it is converted to the motion vectors and reference indices of the current sub-CU in a similar way as the TMVP process of HEVC, where temporal motion scaling is applied to align the reference pictures of the temporal motion vectors to those of the current CU.

In VVC, a combined subblock based merge list which contains both SbTVMP candidate and affine merge candidates is used for the signalling of subblock based merge mode. The SbTVMP mode is enabled/disabled by a sequence parameter set (SPS) flag. If the SbTMVP mode is enabled, the SbTMVP predictor is added as the first entry of the list of subblock based merge candidates, and followed by the affine merge candidates. The size of subblock based merge list is signalled in SPS and the maximum allowed size of the subblock based merge list is 5 in VVC.

The sub-CU size used in SbTMVP is fixed to be 8×8, and as done for affine merge mode, SbTMVP mode is only applicable to the CU with both width and height are larger than or equal to 8.

The encoding logic of the additional SbTMVP merge candidate is the same as for the other merge candidates, that is, for each CU in P or B slice, an additional RD check is performed to decide whether to use the SbTMVP candidate.

### 2.12. IBC-CIIP, IBC-GPM, and IBC-LIC

### 2.12.1. The First Scheme of IBC-CHIP

Combined intra block copy and intra prediction (IBC-CIIP) is a coding tool for a CU which uses IBC with merge mode and intra prediction to obtain two prediction signals, and the two prediction signals are weighted summed to generate the final prediction. Specifically, if the intra prediction is planar or DC mode, the final prediction is obtained as follows:

$$P = ( {w}_{ibc} * {P}_{ibc} + ( ( 1 ≪ shift ) - {w}_{ibc} ) * {P}_{intra} + ( 1 ≪ ( shift - 1 ) ) ) ≫ shift$$

wherein P_{ibc} and Pᵢₙₜᵣₐ denote the IBC prediction signal and intra prediction signal, respectively. (w_{ibc}, shift) are set equal to (1, 2) if both the up and left CUs are intra coded, (2, 2) if one of the up and left CUs are intra coded, (3, 2) if both the up and left CUs are IBC coded. Otherwise (i.e., if the intra prediction is directional mode), the final prediction is obtained by adaptively switching the prediction samples of the intra mode and the IBC. For purpose of illustration, assuming the size of the current CU is w*h and the intra mode is horizontal or vertical, the left ¾w*h part (horizontal mode) or top w*¾h part (vertical mode) of the final prediction is set to intra prediction signal if both the top and left neighboring CUs are intra coded; and the left ½w*h part (horizontal mode) or the top w*½h part (vertical mode) of the final prediction is set to intra prediction signal if only one of the top and left CUs are intra coded; and the left ¼w*h part (horizontal mode) or the top w*¼h part (vertical mode) of the final prediction is set to intra prediction signal if both the up and left CUs are IBC or inter coded. In the above, besides the intra prediction portion, the other part of the final prediction is set to the IBC prediction samples.

### 2.12.2. The Second Scheme of IBC-CHIP

Combined intra block copy and intra prediction (IBC-CIIP) is a coding tool for a CU which uses IBC and intra prediction to obtain two prediction signals, and the two prediction signals are weighted summed to generate the final prediction as follows:

$$P = ( {w}_{ibc} * {P}_{ibc} + ( ( 1 ≪ shift ) - {w}_{ibc} ) * {P}_{intra} + ( 1 ≪ ( shift - 1 ) ) ) ≫ shift$$

wherein P_{ibc} and Pᵢₙₜᵣₐ denote the IBC prediction signal and intra prediction signal. (w_{ibc}, shift) are set equal to (13, 4) and (1, 1) for IBC merge mode and IBC AMVP mode.

An intra prediction mode (IPM) candidate list is used to generate the intra prediction signal, and the IPM candidate list size is pre-defined as 2. An IPM index is signalled to indicate which IPM is used.

2.12.3. IBC with Geometry Partitioning (IBC-GPM)

Intra block copy with geometry partitioning mode (IBC-GPM) is a coding tool which divides a CU into two sub-partitions geometrically. The prediction signals of the two sub-partitions are generated using IBC and intra prediction. IBC-GPM can be applied to regular IBC merge mode or IBC-TM merge mode. An intra prediction mode (IPM) candidate list is constructed using the same method as GPM with inter and intra prediction for intra prediction, and the IPM candidate list size is pre-defined as 3. There are 48 geometry partitioning modes in total, which are divided into two geometry partitioning mode sets as follows:

TABLE 1
Geometry partitioning modes in the first
geometry partitioning mode set

| ibc_gpm_partition_idx | 0 | 1 | 2 | 3 | 4 | 5 | 6 | 7 |
|---|---|---|---|---|---|---|---|---|
| angleIdx | 0 | 0 | 8 | 8 | 16 | 16 | 24 | 24 |
| distanceIdx | 1 | 3 | 1 | 3 | 1 | 3 | 1 | 3 |

TABLE 2
Geometry partitioning modes in the second
geometry partitioning mode set

| ibc_gpm_partition_idx | 0 | 1 | 2 | 3 | 4 | 5 | 6 | 7 | 8 | 9 |
|---|---|---|---|---|---|---|---|---|---|---|
| angleIdx | 2 | 2 | 2 | 3 | 3 | 3 | 4 | 4 | 4 | 5 |
| distanceIdx | 0 | 1 | 3 | 0 | 1 | 3 | 0 | 1 | 3 | 0 |
| ibc_gpm_partition_idx | 10 | 11 | 12 | 13 | 14 | 15 | 16 | 17 | 18 | 19 |
| angleIdx | 5 | 5 | 11 | 11 | 11 | 12 | 12 | 12 | 13 | 13 |
| distanceIdx | 1 | 3 | 0 | 1 | 3 | 0 | 1 | 3 | 0 | 1 |
| ibc_gpm_partition_idx | 20 | 21 | 22 | 23 | 24 | 25 | 26 | 27 | 28 | 29 |
| angleIdx | 13 | 14 | 14 | 14 | 18 | 18 | 19 | 19 | 20 | 20 |
| distanceIdx | 3 | 0 | 1 | 3 | 1 | 3 | 1 | 3 | 1 | 3 |
| ibc_gpm_partition_idx | 30 | 31 | 32 | 33 | 34 | 35 | 36 | 37 | 38 | 39 |
| angleIdx | 21 | 21 | 27 | 27 | 28 | 28 | 29 | 29 | 30 | 30 |
| distanceIdx | 1 | 3 | 1 | 3 | 1 | 3 | 1 | 3 | 1 | 3 |

When IBC-GPM is used, an IBC-GPM geometry partitioning mode set flag is signalled to indicate whether the first or the second geometry partitioning mode set is selected, followed by the geometry partitioning mode index. An IBC-GPM intra flag is signalled to indicate whether intra prediction is used for the first sub-partition. When intra prediction is used for a sub-partition, an intra prediction mode index is signalled. When IBC is used for a sub-partition, a merge index is signalled.

2.12.4. IBC with Local Illumination Compensation (IBC-LIC)

Intra block copy with local illumination compensation (IBC-LIC) is a coding tool which compensates the local illumination variation within a picture between the CU coded with IBC and its prediction block with a linear equation. The parameters of the linear equation are derived same as LIC for inter prediction except that the reference template is generated using block vector in IBC-LIC. IBC-LIC can be applied to IBC AMVP mode and IBC merge mode. For IBC AMVP mode, an IBC-LIC flag is signalled to indicate the use of IBC-LIC. For IBC merge mode, the IBC-LIC flag is inferred from the merge candidate.

### 3. PROBLEMS

In current BV prediction (e.g., for both IBC merge and IBC AMVP mode), temporal BV prediction is not utilized. To further improve the efficiency of BV prediction, temporal BV prediction is introduced.

### 4. DETAILED SOLUTIONS

The detailed embodiments below should be considered as examples to explain general concepts. These embodiments should not be interpreted in a narrow way. Furthermore, these embodiments can be combined in any manner.
The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.
W and H are the width and height of current block (e.g., luma block).
For an IBC and Intra TMP coded block, a block vector (BV) is used to indicate the displacement from the current block to a reference block, which is already or partially reconstructed inside the current picture.
In the following, a BV candidate is a BV predictor or a searching point. One block has BV information if it is IBC coded or Intra TMP coded.

### Temporal BV Prediction

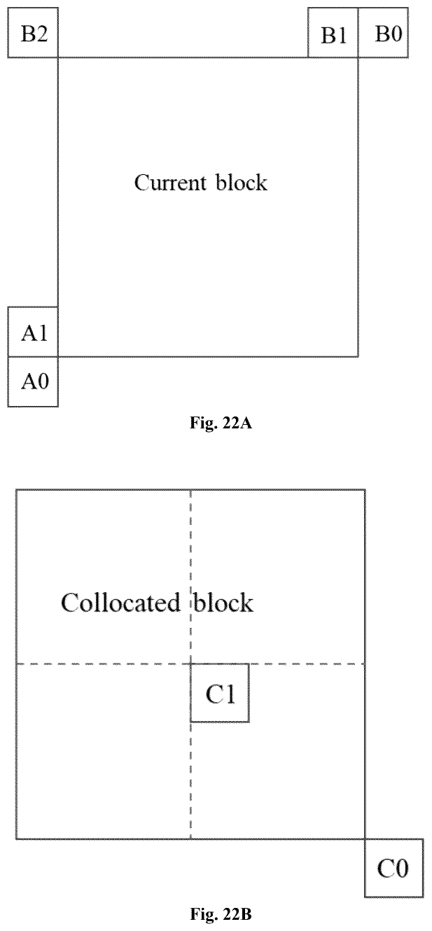

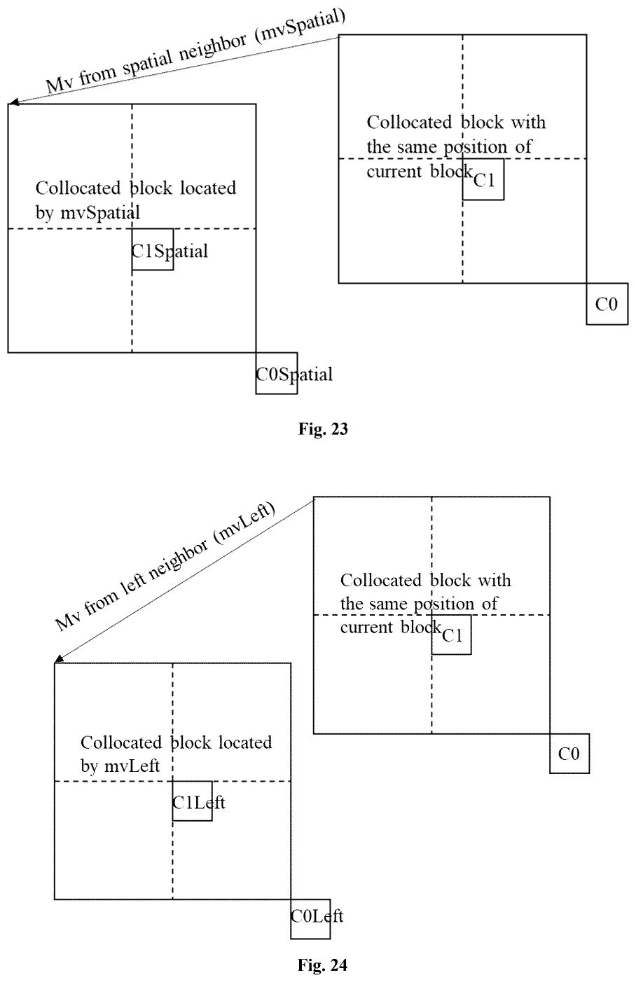

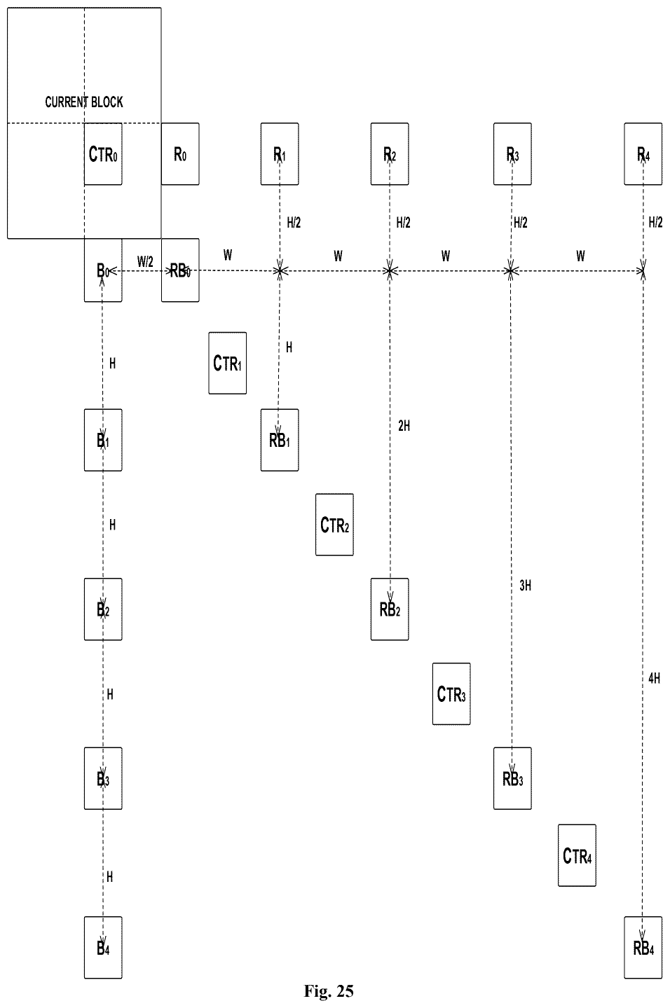

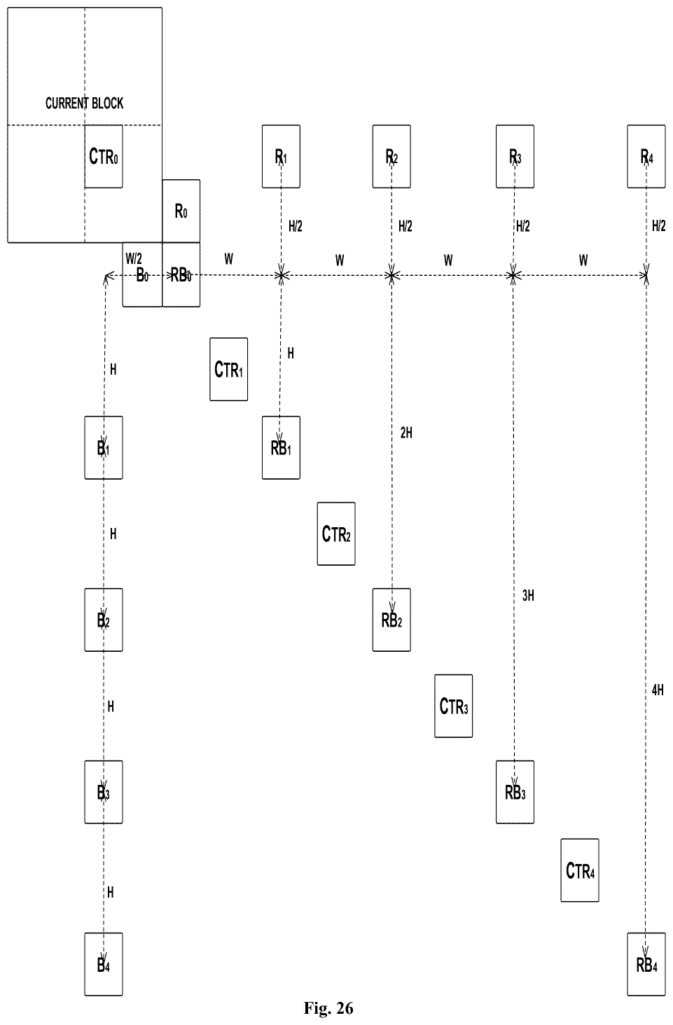

1. In one example, a temporal BV prediction may be introduced in BV prediction.
   a. In one example, the BV prediction may be at least one of the following.
      (a) In one example, the BV prediction may be regular IBC merge prediction.
      (b) In one example, the BV prediction may be regular IBC AMVP prediction.
      (c) In one example, the BV prediction may be IBC-TM merge prediction.
      (d) In one example, the BV prediction may be IBC-TM AMVP prediction.
      (e) In one example, the BV prediction may be RR-IBC merge prediction.
      (f) In one example, the BV prediction may be RR-IBC AMVP prediction.
      (g) In one example, the BV prediction may be IBC-MBVD prediction.
      (h) In one example, the BV prediction may be string copy vector prediction.
      (i) In one example, the BV prediction may be any other BV prediction.
2. In one example, a temporal BV candidate may be introduced in BV candidate list.
   a. In one example, the BV candidate list may be at least one of the following.
      (a) In one example, the BV candidate list may be regular IBC merge list.
      (b) In one example, the BV candidate list may be regular IBC AMVP list.
      (c) In one example, the BV candidate list may be IBC-TM merge list.
      (d) In one example, the BV candidate list may be IBC-TM AMVP list.
      (e) In one example, the BV candidate list may be RR-IBC merge list.
      (f) In one example, the BV candidate list may be RR-IBC AMVP list.
      (g) In one example, the BV candidate list may be IBC-MBVD base candidate list.
      (h) In one example, the BV candidate list may be any other BV candidate list.
3. In one example, a temporal BV prediction or candidate may be derived in at least one of the following methods.
   a. In one example, if a motion grid (such as 4×4 grid) that covers one temporal position is available, has BV information, and its BV is valid for current block, this temporal position may be used for the temporal BV candidate derivation.
   b. In one example, if a motion grid (such as 4×4 grid) that covers one temporal position is not available, or does not have BV information, or its BV is invalid for current block, this temporal position may be not used for the temporal BV candidate derivation.
   c. In one example, if a motion grid (such as 4×4 grid) that covers one temporal position is outside of the CTU row of current block, this temporal position may be clipped to inside the CTU row of current block and then used for the temporal BV candidate derivation.
      (a) Alternatively, if a motion grid (such as 4×4 grid) that covers one temporal position is outside of the CTU row of current block, this temporal position may be not used for the temporal BV candidate derivation.
   d. In one example, the position for the temporal BV candidate may be selected between several positions in a collocated picture.
      (a) The positions comprise C0 and C1 in the collocated picture as depicted in FIG. 22B which illustrates candidate positions for temporal candidate.
      (b) C0 may be checked first. If no BV can be obtained in C0, C1 is checked.
      (c) C1 may be checked first. If no BV can be obtained in C1, C0 is checked.
      (d) If CU at position C0 is not available, does not have BV information, is outside of the CTU row of current block or its BV is invalid for current block, position C1 is used. Otherwise, position C0 is used in the derivation of the temporal BV candidate. That means the priority order is C0->C1.
      (e) Alternatively, the position for the temporal BV candidate may be selected between positions C0 and C1 in the collocated picture, as depicted in FIG. 22B. If CU at position C1 is not available, does not have BV information, is outside of the CTU row of current block or its BV is invalid for current block, position C0 is used. Otherwise, position C1 is used in the derivation of the temporal BV candidate. That means the priority order is C1->C0.
   e. Alternatively, when deriving the temporal BV candidate, both candidates corresponding to positions C0 and C1 in the collocated picture, as depicted in FIG. 22B, can be used.
      (a) For example, the derivation order is C0, C1.
      (b) Alternatively, the derivation order is C1, C0.
   f. In one example, when deriving a temporal BV candidate from a temporal position in a collocated picture, perhaps only BV is inherited.
   g. In one example, when deriving a temporal BV candidate from a temporal position in a collocated picture, both BV and IBC-LIC flag may be inherited.
   h. In one example, the width and height of the collocated block in the collocated picture may be the same as the width and height of current block in current picture.
   i. In one example, the position of the collocated block in the collocated picture may be the same as the position of current block in current picture.
   j. In one example, the position of the collocated block in the collocated picture may be determined by one motion shift added to the position of current block in current picture.
      (a) In one example, the motion shift may be a motion vector of one spatial neighbor.
         1) In one example, the spatial neighbor may be left (A1), above (B1), above-right (B0), bottom-left (A0), or above-left (B2) neighbor in FIG. 22A which illustrates candidate positions for spatial candidate.
         2) In one example, if the spatial neighbor has a motion vector that uses the collocated picture as its reference picture, this motion vector may be selected to be the motion shift; if no such motion is identified, the spatial neighbor may not provide the motion shift or the motion shift is set to (0, 0).
         3) In one example, if the spatial neighbor has a motion vector that uses the collocated picture as its reference picture, this motion vector may be selected to be the motion shift; if no such motion is identified, one motion vector of either reference list 0 or reference list 1 may be scaled to point to the collocated picture and the scaled motion vector may be used as the motion shift.
         4) In one example, the motion shift may be derived in a predefined priority order, the first N valid motion vector(s) may be used as the motion shift(s).
         i. In one example, N may be 1, 2, 3, 4, or 5.
         ii. In one example, the priority order may be A1->B1->B0->A0->B2.
         iii. In one example, the priority order may be B1->A1->B0->A0->B2.
         iv. In one example, the priority order may be A0->A1->B0->B1->B2.
      (b) In one example, the motion shift(s) with the first M minimum template matching cost(s) may be used to derive the temporal BV candidates.
         1) In one example, M may be 1, 2, 3, 4, or 5.
   k. In one example, when deriving the temporal BV candidates, at least one of the candidate selected from positions C0 or C1, the candidate selected from positions C0Left or C1Left, the candidate selected from positions C0Above or C1Above, the candidate selected from positions C0AboveRight or C1AboveRight, the candidate selected from positions C0BottomLeft or C1BottomLeft, the candidate selected from positions C0AboveLeft or C1AboveLeft, in the collocated picture, as depicted in FIG. 23, can be used, where CXSpatial is the motion shift derived from the spatial neighbor added to CX (X is 0 or 1, Spatial is Left, Above, Above-right, Bottom-left, or Above-left). FIG. 23 illustrates candidate positions for the temporal BV candidates, spatial can be Left, Above, Above-right, Bottom-left, or Above-left.
      (a) In one example, at most six temporal BV candidates may be derived.
      (b) In one example, when deriving the temporal BV candidates, the candidate selected from positions C0 or C1, the candidate selected from positions C0Left or C1Left, in the collocated picture, as depicted in FIG. 24, can be used. In this example, at most two temporal BV candidates may be derived. FIG. 24 illustrates candidate positions for the temporal BV candidates.
      (c) In one example, the priority order of C0 and C1 is C0->C1.
      (d) In one example, the priority order of C0 and C1 is C1->C0.
      (e) In one example, the priority order of C0Spatial and C1Spatial may be the same as the priority order of C0 and C1.
         1) In one example, Spatial may be Left, Above, Above-right, Bottom-left, or Above-left.
      (f) In one example, the priority order of C0Spatial and C1Spatial may be the opposite of the priority order of C0 and C1.
         1) In one example, Spatial may be Left, Above, Above-right, Bottom-left, or Above-left.
   l. In one example, when deriving the temporal BV candidates, at least one of the candidates derived from positions C0 and C1, the candidates derived from positions C0Left and C1Left, the candidates derived from positions C0Above and C1Above, the candidates derived from positions C0AboveRight and C1AboveRight, the candidates derived from positions C0BottomLeft and C1BottomLeft, the candidates derived from positions C0AboveLeft and C1AboveLeft, in the collocated picture, as depicted in FIG. 23, can be used, where CXSpatial is the motion shift derived from the spatial neighbor added to CX (X is 0 or 1, Spatial is Left, Above, Above-right, Bottom-left, or Above-left).
      (a) In one example, at most 12 temporal BV candidates may be derived.
      (b) In one example, when deriving the temporal BV candidates, the candidates derived from positions C0 and C1, the candidates derived from positions C0Left and C1Left, in the collocated picture, as depicted in FIG. 24, can be used. In this example, at most four temporal BV candidates may be derived.
      (c) In one example, the derivation order of C0 and C1 is C0, C1.
      (d) In one example, the derivation order of C0 and C1 is C1, C0.
      (e) In one example, the derivation order of C0Spatial and C1Spatial may be the same as the derivation order of C0 and C1.
         1) In one example, Spatial may be Left, Above, Above-right, Bottom-left, or Above-left.
      (f) In one example, the derivation order of C0Spatial and C1Spatial may be the opposite of the derivation order of C0 and C1.
         1) In one example, Spatial may be Left, Above, Above-right, Bottom-left, or Above-left.
   m. In one example, the temporal BV candidates may be derived from some certain temporal positions.
      (a) In one example, the temporal positions may be predefined.
      (b) In one example, the temporal positions may be derived based on some coding information.
      (c) In one example, the temporal positions may be derived based on at least one of the position, width, or height of current block.
      (d) In one example, the distances between temporal BV candidates and current coding block may be based on the width and height of current coding block.
         1) In one example, the pattern of temporal BV candidates is shown in FIG. 25. FIG. 25 illustrates a first pattern of candidate positions for the temporal BV candidates. For each search round, four temporal positions are checked. For each search round i (i>=0), the four temporal positions are {(x+W+i*W), (y+H+i*H)}(RBᵢ), {(x+W/2+i*W), (y+H/2+i*H)}(Ctrᵢ), {(x+W+i*W), (y+H/2)}(Rᵢ), and {(x+W/2), (y+H+i*H)}(Bᵢ).
         i. In one example, If five search rounds are used, the 20 temporal positions are {(x+W), (y+H)}, {(x+W/2), (y+H/2)}, {(x+W), (y+H/2)}, {(x+W/2), (y+H)}, {(x+W+W), (y+H+H)}, {(x+W/2+W), (y+H/2+H)}, {(x+W+W), (y+H/2)}, {(x+W/2), (y+H+H)}, {(x+W+2*W), (y+H+2*H)}, {(x+W/2+2*W), (y+H/2+2*H)}, {(x+W+2*W), (y+H/2)}, {(x+W/2), (y+H+2*H)}, {(x+W+3*W), (y+H+3*H)}, {(x+W/2+3*W), (y+H/2+3*H)}, {(x+W+3*W), (y+H/2)}, {(x+W/2), (y+H+3*H)}, {(x+W+4*W), (y+H+4*H)}, {(x+W/2+4*W), (y+H/2+4*H)}, {(x+W+4*W), (y+H/2)}, and {(x+W/2), (y+H+4*H)}.
         i. In one example, for each search round i, derive one temporal BV candidate in the priority order of RBᵢ->Ctrᵢ, derive one temporal BV candidate in the priority order of Rᵢ->Bᵢ, at most two temporal BV candidates may be derived.
         ii. In one example, for each search round i, the derivation order is RBᵢ, Ctrᵢ, Rᵢ, Bᵢ, at most four temporal BV candidates may be derived.
         2) In one example, the pattern of temporal BV candidates is shown in FIG. 26. FIG. 26 illustrates a second pattern of candidate positions for the temporal BV candidates. For each search round, four temporal positions are checked. For each search round i (i>=1), the four temporal positions are {(x+W+i*W), (y+H+i*H)}(RBᵢ), {(x+W/2+i*W), (y+H/2+i*H)}(Ctrᵢ), {(x+W+i*W), (y+H/2)}(Rᵢ), and {(x+W/2), (y+H+i*H)}(Bᵢ). For each search round 0, the four temporal positions are {(x+W), (y+H)}(RB₀), {(x+W/2), (y+H/2)}(Ctr₀), {(x+W), (y+H−4)}(R₀), {(x+W−4), (y+H)}(B₀).
         i. In one example, If five search rounds are used, the 20 temporal positions are {(x+W), (y+H)}, {(x+W/2), (y+H/2)}, {(x+W), (y+H−4))}, {(x+W−4), (y+H)}, {(x+W+W), (y+H+H)}, {(x+W/2+W), (y+H/2+H)}, {(x+W+W), (y+H/2)}, {(x+W/2), (y+H+H)}, {(x+W+2*W), (y+H+2*H)}, {(x+W/2+2*W), (y+H/2+2*H)}, {(x+W+2*W), (y+H/2)}, {(x+W/2), (y+H+2*H)}, {(x+W+3*W), (y+H+3*H)}, {(x+W/2+3*W), (y+H/2+3*H)}, {(x+W+3*W), (y+H/2)}, {(x+W/2), (y+H+3*H)}, {(x+W+4*W), (y+H+4*H)}, {(x+W/2+4*W), (y+H/2+4*H)}, {(x+W+4*W), (y+H/2)}, and {(x+W/2), (y+H+4*H)}.
         ii. In one example, for each search round i, derive one temporal BV candidate in the priority order of RBᵢ->Ctrᵢ, derive one temporal BV candidate in the priority order of Rᵢ->Bᵢ, at most two temporal BV candidates may be derived.
         iii. In one example, for each search round i, the derivation order is RBᵢ, Ctrᵢ, Rᵢ, Bᵢ, at most four temporal BV candidates may be derived.
         3) In one example, any other pattern of temporal BV candidates may be used.
   n. In one example, all the temporal BV candidates mentioned above can be combined in any manner.
   o. In one example, there may be a constraint on the maximum number (e.g., N) of temporal BV candidates.
      (a) In one example, the number of temporal BV candidates may be not larger than 5.
      (b) In one example, the number of temporal BV candidates may be not larger than 4.
      (c) Alternatively, there may be a constraint on the maximum number (e.g., M) of temporal BV candidates which may be unique (e.g., after full pruning) to be derived.
         1) In one example, M may be 5.
         2) In one example, M may be 4.
         3) In one example, M may be 3.
         4) In one example, M may vary depending on coding mode of current block.
         i. In one example, for IBC-TM AMVP and/or IBC-TM merge mode, M may be 1 or 2; for other IBC mode, M may be 4 or 5.
         5) In one example, M may vary depending on picture/slice type.
         i. In one example, if the POCs of all the reference pictures of current slice/picture are smaller than the POC of current slice/picture, M may be M1; if the POC of at least one reference picture of current slice/picture is larger than the POC of current slice/picture, M may be M2.
         (i) In one example, M1 may be 2; M2 may be 3.
   p. In one example, a redundancy check or pruning may be performed when deriving the temporal BV candidates.
      (a) In one example, a full pruning may be performed when deriving the temporal BV candidates to ensure that candidates with the same or similar motion information are excluded from the BV candidate list.
      (b) In one example, a partial pruning may be performed when deriving the temporal BV candidates.
   q. In one example, the positions of temporal BV candidates in the BV candidate list may be one of the following.
      (a) In one example, all the temporal BV candidates may be inserted before the HMVP candidates.
      (b) In one example, partial of the temporal BV candidates may be inserted before the HMVP candidates, and the remaining of the temporal BV candidates may be inserted after the HMVP candidates.
      (c) In one example, all the temporal BV candidates may be inserted after the HMVP candidates.
4. In one example, the number of the collocated pictures for deriving the temporal BV/MV candidates may be N (e.g., N is a positive integer).
   a. In one example, N may be larger than or equal to 1.
   b. In one example, the indication of the collocated pictures for deriving the temporal BV candidates may be signalled at sequence level/group of pictures level/picture level/slice level/tile group level, such as in sequence header/picture header/SPS/VPS/DPS/DCI/PPS/APS/slice header/tile group header.
   c. In one example, N reference pictures with the first N least POC distances relative to current picture may be selected to be the collocated pictures.
   d. In one example, N reference pictures with the first N least QP differences relative to current picture may be selected to be the collocated pictures.
   e. In one example, N reference pictures with the first N smallest QPs may be selected to be the collocated pictures.
5. In one example, whether to use temporal BV prediction (TBVP) and whether to use temporal MV prediction (TMVP) may use one same indication.
   a. In one example, whether to use temporal BV prediction (TBVP) and whether to use temporal MV prediction (TMVP) may use different indications.
   b. In one example, whether to use temporal BV prediction (TBVP) may be signalled at sequence level/group of pictures level/picture level/slice level/tile group level, such as in sequence header/picture header/SPS/VPS/DPS/DCI/PPS/APS/slice header/tile group header.

### BV Candidate Reordering

6. In one example, the reordering/refinement process may be performed when deriving the BV candidate list.
   a. In one example, the reordering/refinement process may be based on template matching cost(s).
   b. In one example, when constructing the BV candidate list, N1 adjacent spatial candidates and/or N2 temporal candidates and/or N3 HMVP candidates and/or N4 pairwise average candidates and/or N5 predefined BV candidates may be partially or all derived with full pruning to make sure there are no duplicate or similar candidates in the list and then reordered together. After reordering, the first N candidates (such as with the lowest costs) may be selected as the final candidates in the BV candidate list.
      i. In one example, N may be 6 and/or N1 may be 5 and/or N2 may be 10 and/or N3 may be 25 and/or N4 may be 1 and/or N5 may be 6.
      ii. In one example, there may be a constraint on the maximum number (e.g., M) of BV candidates which may be unique (e.g., after full pruning) to be derived.
         (i) In one example, M may be 20.
      iii. In one example, the adjacent spatial BV candidates may consist of left and/or above and/or above-right and/or bottom-left and/or above-left spatial candidates (an example is shown in FIG. 22A).
      iv. In one example, the temporal BV candidates may consist of those specified in bullet 3.
      v. In one example, the number of HMVP BV candidates and/or the HMVP table size may be increased to N2 (e.g., 25).
      vi. In one example, for a pairwise BV candidate, it may be generated by averaging predefined pairs of existing candidates in the motion candidate list.
         (ii) In one example, a predefined pair may be defined as a pair in a set such as {(0, 1), (0, 2), (1, 2), (0, 3), (1, 3), (2, 3)}, where the numbers denote the motion candidate indices in the motion candidate list.
      vii. In one example, the predefined BV candidates may be located in the IBC reference region.
   c. In one example, a BV candidate type based ARMC may be used to reorder the BV candidates with one specific candidate type or multiple specific candidate types according to one or some criteria.
      i. In one example, M candidates (such as with the lowest costs) with a specific candidate type may be selected out of the N reordered candidates with the candidate type when constructing the BV candidate list.
         (i) In one example, M may vary depending on candidate types and/or coding mode of current block.
         (ii) In one example, the candidate type may be adjacent spatial BV candidates. For an example, M is 4, N is 5.
         (iii) In one example, the candidate type may be temporal BV candidates. For an example, M is 4, N is 10.
         (iv) In one example, the candidate type may be HMVP BV candidates. For an example, M is 10, N is 25.
         (v) In one example, the candidate type may be pairwise average BV candidates. For an example, M is 1, N is 6.
         (vi) In one example, the candidate type may be predefined BV candidates. For an example, M is 1, N is 6.
      ii. In one example, multiple BV candidate types (i.e., candidate type combination) may be reordered together.
         (i) In one example, M candidates (such as with the lowest costs) with any of the specific BV candidate types may be selected out of the N reordered candidates in the candidate type combination when constructing the BV candidate list, where M may vary depending on candidate type combinations and/or coding mode of current block.
         (ii) In one example, adjacent spatial candidates and/or temporal candidates and/or HMVP candidates and/or pairwise average candidates and/or predefined BV candidates may be reordered together. For an example, M is 6, N is 20.
         (iii) In one example, at least one BV candidate types of BV candidates may be firstly reordered using the BV candidate type based ARMC.
         (iv) In one example, N1 HMVP candidates (such as with the lowest costs) may be selected out of the reordered candidates with the HMVP candidate type, and the selected N1 HMVP candidates may be reordered together with the adjacent spatial candidates and/or temporal candidates and/or pairwise average candidates and/or predefined BV candidates. M candidates (such as with the lowest costs) may be selected in the finally.
         (v) In one example, N2 temporal candidates (such as with the lowest costs) may be selected out of the reordered candidates with the temporal candidate type, and the selected N2 temporal candidates may be reordered together with the adjacent spatial candidates and/or HMVP candidates and/or pairwise average candidates and/or predefined BV candidates. M candidates (such as with the lowest costs) may be selected in the finally.
         (vi) In one example, if one candidate is reordered more than one times, its reordering criterion (e.g., template matching cost) may be reused.

### BVP for SbTMVP

7. In one example, a BVP can be obtained for a subblock (such as 4×4 or 8×8) of a block which is coded with SbTMVP.
   a. In one example, the BVP may be fetched from a temporal position in the collocated block located by SbTMVP.

### General Information

8. A syntax element disclosed above may be binarized as a flag, a fixed length code, an EG(x) code, a unary code, a truncated unary code, a truncated binary code, etc. It can be signed or unsigned.
9. A syntax element disclosed above may be coded with at least one context model. Or it may be bypass coded.
10. A syntax element (SE) disclosed above may be signaled in a conditional way.
   a. The SE is signaled only if the corresponding function is applicable.
11. A syntax element disclosed above may be signaled at block level/sequence level/group of pictures level/picture level/slice level/tile group level, such as in coding structures of CTU/CU/TU/PU/CTB/CB/TB/PB, or sequence header/picture header/SPS/VPS/DPS/DCI/PPS/APS/slice header/tile group header.
12. In above examples, the block may refer to the colour component/sub-picture/slice/tile/coding tree unit (CTU)/CTU row/groups of CTU/coding unit (CU)/prediction unit (PU)/transform unit (TU)/coding tree block (CTB)/coding block (CB)/prediction block (PB)/transform block (TB)/a block/sub-block of a block/sub-region within a block/any other region that contains more than one sample or pixel.
13. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
14. Whether to and/or how to apply the disclosed methods above may be signalled at PB/TB/CB/PU/TU/CU/VPDU/CTU/CTU row/slice/tile/sub-picture/other kinds of region contains more than one sample or pixel.
15. Whether to and/or how to apply the disclosed methods above may be dependent on coded information, such as block size, colour format, single/dual tree partitioning, colour component, slice/picture type.

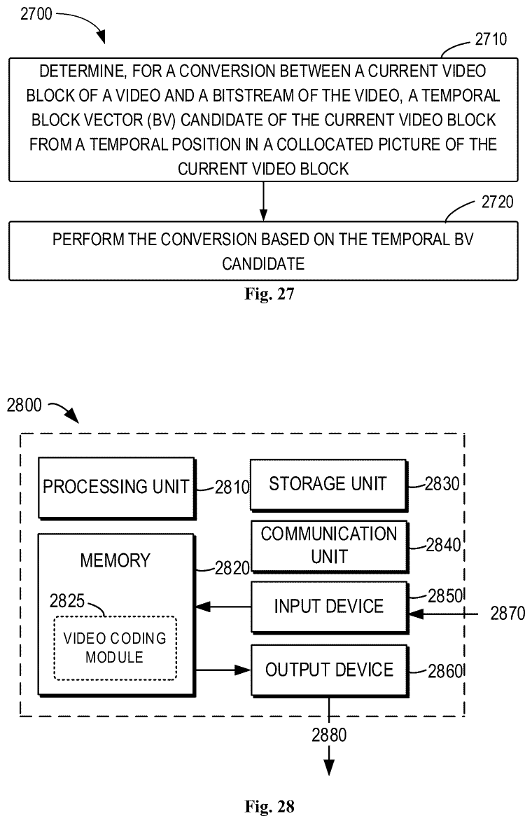

FIG. 27 illustrates a flowchart of a method 2700 for video processing in accordance with embodiments of the present disclosure. The method 2700 is implemented for a conversion between a current video block of a video and a bitstream of the video. In some embodiments, the conversion may include encoding the current video block into the bitstream. Alternatively, or in addition, the conversion may include decoding the current video block from the bitstream.

At block 2710, a temporal block vector (BV) candidate of the current video block is determined from a temporal position in a collocated picture of the current video block.

At block 2720, the conversion is performed based on temporal BV candidate. At least one of a BV or a flag of intra block copy with local illumination compensation (IBC-LIC) is inherited from the temporal position.

The method 2700 enables inheriting the BV and/or the IBC-LIC flag. In this way, the coding efficiency and coding effectiveness can thus be improved.

In some embodiments, the BV is inherited without inheriting the flag of IBC-LIC. That is, only the BV may be inherited. Alternatively, or in addition, in some embodiments, both the BV and the flag of IBC-LIC may be inherited.

In some embodiments, the number of temporal BV candidates of the current video block is less than or equal to a threshold number. For example, a plurality of temporal BV candidates may be determined for the current video block. The number of the plurality of temporal BV candidates should be less than or equal to the threshold number.

In some embodiments, at least one pattern of temporal BV candidates is used. For example, the at least one pattern may be the first pattern shown in FIG. 25, or the second pattern shown in FIG. 26. Alternatively, any other pattern of temporal BV candidates may be used.

In some embodiments, the temporal BV candidates may include a first temporal BV candidate determined in a first manner and a second temporal BV candidate determined in a second manner. For example, all the temporal BV candidates mentioned above can be combined in any manner.

In some embodiments, the temporal BV candidates are processed by a full pruning process. That is, each temporal BV candidates may be unique. The total number of these unique temporal BV candidates is less than or equal to the threshold number.

In some embodiments, the threshold number is based on at least one of: a picture type, or a slice type.

In some embodiments, if at least one picture order count (POC) of at least one reference picture of a current slice or a current picture is smaller than a POC of the current slice or the current picture, the threshold number is a first value. In some embodiments, the at least one POC of at least one reference picture comprises all POCs of all reference pictures of the current slice or the current picture. That is, if all POCs of all reference pictures are smaller than the POC of the current slice or the current picture, the threshold may be equal to the first value. By way of example, the first value may be 2, or any other suitable value.

Alternatively, or in addition, in some embodiments, if at least one POC of at least one reference picture of a current slice or a current picture is larger than a POC of the current slice or the current picture, the threshold number is a second value. By way of example, the second value may be 3.

In some embodiments, the threshold number may be 3 or any other suitable number. The threshold number may be determined based on any other suitable parameter or rules. Scope of embodiments of the present disclosure is not limited here.

In some embodiments, a syntax element in the bitstream is binarized as at least one of: a flag, a fixed length code, an exponential Golomb (EG) (x) code, a unary code, a truncated unary code, or a truncated binary code. In some embodiments, the syntax element is signed or unsigned.

In some embodiments, a syntax element in the bitstream is coded with at least one context model, or bypass coded.

In some embodiments, the syntax element is included in the bitstream based on a condition. For example, the condition may be that a function associated with the syntax element is applicable.

In some embodiments, the syntax element is at at least one of: a block level, a sequence level, a group of pictures level, a picture level, a slice level, or a tile group level.

In some embodiments, the syntax element is in a coding structure, the coding structure comprising at least one of: a coding tree unit (CTU), a coding unit (CU), a transform unit (TU), a prediction unit (PU), a coding tree block (CTB), a coding block (CB), a transform block (TB), a prediction block (PB), a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header or a tile group header.

In some embodiments, the current video block comprises one of: a color component, a sub-picture, a slice, a tile, a coding tree unit (CTU), a CTU row, groups of CTUs, a coding unit (CU), a prediction unit (PU), a transform unit (TU), a coding tree block (CTB), a coding block (CB), a prediction block (PB), a transform block (TB), a block, a sub-block of a block, a sub-region within a block, or a region that contains more than one sample or pixel.

In some embodiments, information regarding whether to and/or how to apply the method 2700 is included in the bitstream.

In some embodiments, the information is indicated at one of: a sequence level, a group of pictures level, a picture level, a slice level or a tile group level.

In some embodiments, the information is indicated in a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header or a tile group header.

In some embodiments, the information is indicated in a region containing more than one sample or pixel.

In some embodiments, the region comprising one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a subpicture.

In some embodiments, the information is based on coded information.

In some embodiments, the coded information comprises at least one of: a coding mode, a block size, a colour format, a single or dual tree partitioning, a colour component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. In the method, a temporal block vector (BV) candidate of a current video block of the video is determined from a temporal position in a collocated picture of the current video block. The bitstream is generated based on the temporal BV candidate. At least one of a BV or a flag of IBC-LIC is inherited from the temporal position.

According to still further embodiments of the present disclosure, a method for storing bitstream of a video is provided. In the method, a temporal block vector (BV) candidate of a current video block of the video is determined from a temporal position in a collocated picture of the current video block. The bitstream is generated based on the temporal BV candidate. The bitstream is stored in a non-transitory computer-readable recording medium. At least one of a BV or a flag of IBC-LIC is inherited from the temporal position.

Implementations of the present disclosure can be described in view of the following clauses, the features of which can be combined in any reasonable manner.

Clause 1. A method for video processing, comprising: determining, for a conversion between a current video block of a video and a bitstream of the video, a temporal block vector (BV) candidate of the current video block from a temporal position in a collocated picture of the current video block; and performing the conversion based on the temporal BV candidate, wherein at least one of a BV, or a flag of intra block copy with local illumination compensation (IBC-LIC) is inherited from the temporal position.

Clause 2. The method of clause 1, wherein the BV is inherited without inheriting the flag of IBC-LIC.

Clause 3. The method of clause 1, wherein both the BV and the flag of IBC-LIC is inherited.

Clause 4. The method of any of clauses 1-3, wherein the number of temporal BV candidates of the current video block is less than or equal to a threshold number.

Clause 5. The method of clause 4, wherein the temporal BV candidates are processed by a full pruning process.

Clause 6. The method of clause 4 or 5, wherein the threshold number is based on at least one of: a picture type, or a slice type.

Clause 7. The method of clause 4 or 5, wherein if at least one picture order count (POC) of at least one reference picture of a current slice or a current picture is smaller than a POC of the current slice or the current picture, the threshold number is a first value.

Clause 8. The method of clause 7, wherein the first value is 2.

Clause 9. The method of clause 7, wherein the at least one POC of at least one reference picture comprises all POCs of all reference pictures of the current slice or the current picture.

Clause 10. The method of clause 4 or 5, wherein if at least one picture order count (POC) of at least one reference picture of a current slice or a current picture is larger than a POC of the current slice or the current picture, the threshold number is a second value.

Clause 11. The method of clause 10, wherein the second value is 3.

Clause 12. The method of clause 4 or 5, wherein the threshold number is 3.

Clause 13. The method of any of clauses 1-12, wherein a syntax element in the bitstream is binarized as at least one of: a flag, a fixed length code, an exponential Golomb (EG) (x) code, a unary code, a truncated unary code, or a truncated binary code.

Clause 14. The method of clause 13, wherein the syntax element is signed or unsigned.

Clause 15. The method of any of clauses 1-12, wherein a syntax element in the bitstream is coded with at least one context model, or bypass coded.

Clause 16. The method of any of clauses 13-15, wherein the syntax element is included in the bitstream based on a condition, wherein the condition comprises that a function associated with the syntax element is applicable.

Clause 17. The method of any of clauses 13-16, wherein the syntax element is at at least one of: a block level, a sequence level, a group of pictures level, a picture level, a slice level, or a tile group level.

Clause 18. The method of any of clauses 13-17, wherein the syntax element is in a coding structure, the coding structure comprising at least one of: a coding tree unit (CTU), a coding unit (CU), a transform unit (TU), a prediction unit (PU), a coding tree block (CTB), a coding block (CB), a transform block (TB), a prediction block (PB), a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header or a tile group header.

Clause 19. The method of any of clauses 1-18, wherein the current video block comprises one of: a color component, a sub-picture, a slice, a tile, a coding tree unit (CTU), a CTU row, groups of CTUs, a coding unit (CU), a prediction unit (PU), a transform unit (TU), a coding tree block (CTB), a coding block (CB), a prediction block (PB), a transform block (TB), a block, a sub-block of a block, a sub-region within a block, or a region that contains more than one sample or pixel.

Clause 20. The method of any of clauses 1-19, wherein information regarding whether to and/or how to apply the method is included in the bitstream.

Clause 21. The method of clause 20, wherein the information is indicated at one of: a sequence level, a group of pictures level, a picture level, a slice level or a tile group level.

Clause 22. The method of clause 20 or clause 21, wherein the information is indicated in a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header or a tile group header.

Clause 23. The method of any of clauses 20-22, wherein the information is indicated in a region containing more than one sample or pixel.

Clause 24. The method of clause 23, wherein the region comprises one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a subpicture.

Clause 25. The method of any of clauses 20-24, wherein the information is based on coded information.

Clause 26. The method of clause 25, wherein the coded information comprises at least one of: a coding mode, a block size, a colour format, a single or dual tree partitioning, a colour component, a slice type, or a picture type.

Clause 27. The method of any of clauses 1-26, wherein the conversion comprises encoding the current video block into the bitstream.

Clause 28. The method of any of clauses 1-26, wherein the conversion comprises decoding the current video block from the bitstream.

Clause 29. An apparatus for video processing comprising a processor and a non-transitory memory with instructions thereon, wherein the instructions upon execution by the processor, cause the processor to perform a method in accordance with any of clauses 1-28.

Clause 30. A non-transitory computer-readable storage medium storing instructions that cause a processor to perform a method in accordance with any of clauses 1-28.

Clause 31. A non-transitory computer-readable recording medium storing a bitstream of a video which is generated by a method performed by an apparatus for video processing, wherein the method comprises: determining a temporal block vector (BV) candidate of a current video block of the video from a temporal position in a collocated picture of the current video block; and generating the bitstream based on the temporal BV candidate, wherein at least one of a BV, or a flag of intra block copy with local illumination compensation (IBC-LIC) is inherited from the temporal position.

Clause 32. A method for storing a bitstream of a video, comprising: determining a temporal block vector (BV) candidate of a current video block of the video from a temporal position in a collocated picture of the current video block; generating the bitstream based on the temporal BV candidate; and storing the bitstream in a non-transitory computer-readable recording medium, wherein at least one of a BV, or a flag of intra block copy with local illumination compensation (IBC-LIC) is inherited from the temporal position.

### Example Device

FIG. 28 illustrates a block diagram of a computing device 2800 in which various embodiments of the present disclosure can be implemented. The computing device 2800 may be implemented as or included in the source device 110 (or the video encoder 114 or 200) or the destination device 120 (or the video decoder 124 or 300).

It would be appreciated that the computing device 2800 shown in FIG. 28 is merely for purpose of illustration, without suggesting any limitation to the functions and scopes of the embodiments of the present disclosure in any manner.

As shown in FIG. 28, the computing device 2800 includes a general-purpose computing device 2800. The computing device 2800 may at least comprise one or more processors or processing units 2810, a memory 2820, a storage unit 2830, one or more communication units 2840, one or more input devices 2850, and one or more output devices 2860.

In some embodiments, the computing device 2800 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2800 can support any type of interface to a user (such as “wearable” circuitry and the like).

The processing unit 2810 may be a physical or virtual processor and can implement various processes based on programs stored in the memory 2820. In a multi-processor system, multiple processing units execute computer executable instructions in parallel so as to improve the parallel processing capability of the computing device 2800. The processing unit 2810 may also be referred to as a central processing unit (CPU), a microprocessor, a controller or a microcontroller.

The computing device 2800 typically includes various computer storage medium. Such medium can be any medium accessible by the computing device 2800, including, but not limited to, volatile and non-volatile medium, or detachable and non-detachable medium. The memory 2820 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2830 may be any detachable or non-detachable medium and may include a machine-readable medium such as a memory, flash memory drive, magnetic disk or another other media, which can be used for storing information and/or data and can be accessed in the computing device 2800.

The computing device 2800 may further include additional detachable/non-detachable, volatile/non-volatile memory medium. Although not shown in FIG. 28, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2840 communicates with a further computing device via the communication medium. In addition, the functions of the components in the computing device 2800 can be implemented by a single computing cluster or multiple computing machines that can communicate via communication connections. Therefore, the computing device 2800 can operate in a networked environment using a logical connection with one or more other servers, networked personal computers (PCs) or further general network nodes.

The input device 2850 may be one or more of a variety of input devices, such as a mouse, keyboard, tracking ball, voice-input device, and the like. The output device 2860 may be one or more of a variety of output devices, such as a display, loudspeaker, printer, and the like. By means of the communication unit 2840, the computing device 2800 can further communicate with one or more external devices (not shown) such as the storage devices and display device, with one or more devices enabling the user to interact with the computing device 2800, or any devices (such as a network card, a modem and the like) enabling the computing device 2800 to communicate with one or more other computing devices, if required. Such communication can be performed via input/output (I/O) interfaces (not shown).

In some embodiments, instead of being integrated in a single device, some or all components of the computing device 2800 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2800 may be used to implement video encoding/decoding in embodiments of the present disclosure. The memory 2820 may include one or more video coding modules 2825 having one or more program instructions. These modules are accessible and executable by the processing unit 2810 to perform the functionalities of the various embodiments described herein.

In the example embodiments of performing video encoding, the input device 2850 may receive video data as an input 2870 to be encoded. The video data may be processed, for example, by the video coding module 2825, to generate an encoded bitstream. The encoded bitstream may be provided via the output device 2860 as an output 2880.

In the example embodiments of performing video decoding, the input device 2850 may receive an encoded bitstream as the input 2870. The encoded bitstream may be processed, for example, by the video coding module 2825, to generate decoded video data. The decoded video data may be provided via the output device 2860 as the output 2880.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, for a conversion between a current video block of a video and a bitstream of the video, a temporal block vector (BV) candidate of the current video block from a temporal position in a collocated picture of the current video block; and
performing the conversion based on the temporal BV candidate,
wherein at least one of a BV, or a flag of intra block copy with local illumination compensation (IBC-LIC) is inherited from the temporal position.

2. The method of claim 1, wherein the BV is inherited without inheriting the flag of IBC-LIC, or
wherein both the BV and the flag of IBC-LIC are inherited.

3. The method of claim 1, wherein the number of temporal BV candidates of the current video block is less than or equal to a threshold number,
wherein the temporal BV candidates are processed by a full pruning process.

4. The method of claim 3, wherein the threshold number is based on at least one of: a picture type, or a slice type.

5. The method of claim 3, wherein if at least one picture order count (POC) of at least one reference picture of a current slice or a current picture is smaller than a POC of the current slice or the current picture, the threshold number is a first value.

6. The method of claim 5, wherein the first value is 2, or
wherein the at least one POC of at least one reference picture comprises all POCs of all reference pictures of the current slice or the current picture.

7. The method of claim 3, wherein if at least one picture order count (POC) of at least one reference picture of a current slice or a current picture is larger than a POC of the current slice or the current picture, the threshold number is a second value, wherein the second value is 3.

8. The method of claim 3, wherein the threshold number is 3.

9. The method of claim 1, wherein a syntax element in the bitstream is binarized as at least one of: a flag, a fixed length code, an exponential Golomb (EG) (x) code, a unary code, a truncated unary code, or a truncated binary code, wherein the syntax element is signed or unsigned.

10. The method of claim 1, wherein a syntax element in the bitstream is coded with at least one context model, or bypass coded.

11. The method of claim 9, wherein the syntax element is included in the bitstream based on a condition, wherein the condition comprises that a function associated with the syntax element is applicable.

12. The method of claim 9, wherein the syntax element is at at least one of: a block level, a sequence level, a group of pictures level, a picture level, a slice level, or a tile group level, or
wherein the syntax element is in a coding structure, the coding structure comprising at least one of: a coding tree unit (CTU), a coding unit (CU), a transform unit (TU), a prediction unit (PU), a coding tree block (CTB), a coding block (CB), a transform block (TB), a prediction block (PB), a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header or a tile group header.

13. The method of claim 1, wherein the current video block comprises one of: a color component, a sub-picture, a slice, a tile, a coding tree unit (CTU), a CTU row, groups of CTUs, a coding unit (CU), a prediction unit (PU), a transform unit (TU), a coding tree block (CTB), a coding block (CB), a prediction block (PB), a transform block (TB), a block, a sub-block of a block, a sub-region within a block, or a region that contains more than one sample or pixel.

14. The method of claim 1, wherein information regarding whether to and/or how to apply the method is included in the bitstream,
wherein the information is indicated at one of: a sequence level, a group of pictures level, a picture level, a slice level or a tile group level, or
wherein the information is indicated in a sequence header, a picture header, a sequence parameter set (SPS), a Video Parameter Set (VPS), a decoded parameter set (DPS), Decoding Capability Information (DCI), a Picture Parameter Set (PPS), an Adaptation Parameter Set (APS), a slice header or a tile group header, or
wherein the information is indicated in a region containing more than one sample or pixel, wherein the region comprises one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a subpicture.

15. The method of claim 1, wherein information regarding whether to and/or how to apply the method is based on coded information, wherein the coded information comprises at least one of: a coding mode, a block size, a colour format, a single or dual tree partitioning, a colour component, a slice type, or a picture type.

16. The method of claim 1, wherein the conversion comprises encoding the current video block into the bitstream.

17. The method of claim 1, wherein the conversion comprises decoding the current video block from the bitstream.

18. An apparatus for video processing comprising a processor and a non-transitory memory with instructions thereon, wherein the instructions upon execution by the processor, cause the processor to:
determine, for a conversion between a current video block of a video and a bitstream of the video, a temporal block vector (BV) candidate of the current video block from a temporal position in a collocated picture of the current video block; and
perform the conversion based on the temporal BV candidate,
wherein at least one of a BV, or a flag of intra block copy with local illumination compensation (IBC-LIC) is inherited from the temporal position.

19. A non-transitory computer-readable storage medium storing instructions that cause a processor to perform acts comprising:
determining, for a conversion between a current video block of a video and a bitstream of the video, a temporal block vector (BV) candidate of the current video block from a temporal position in a collocated picture of the current video block; and
performing the conversion based on the temporal BV candidate,
wherein at least one of a BV, or a flag of intra block copy with local illumination compensation (IBC-LIC) is inherited from the temporal position.

20. A non-transitory computer-readable recording medium storing a bitstream of a video which is generated by a method performed by an apparatus for video processing, wherein the method comprises:
determining a temporal block vector (BV) candidate of a current video block of the video from a temporal position in a collocated picture of the current video block; and
generating the bitstream based on the temporal BV candidate,
wherein at least one of a BV, or a flag of intra block copy with local illumination compensation (IBC-LIC) is inherited from the temporal position.
